(19) United States
(12) Patent Application Publication
(10) Pub. No.: US 2014/0285895 A1
(43) Pub. Date: Sep. 25, 2014

(54) OPTICAL FILTER DEVICE, OPTICAL MODULE AND ELECTRONIC APPARATUS

(71) Applicant: SEIKO EPSON CORPORATION, TOKYO (JP)

(72) Inventors: Daisuke Saito, Matsumoto (JP); Yasushi Matsuno, Matsumoto (JP)

(73) Assignee: SEIKO EPSON CORPORATION, TOKYO (JP)

(21) Appl. No.: 14/222,959

(22) Filed: Mar. 24, 2014

(30) Foreign Application Priority Data
Mar. 25, 2013 (JP) 2013-061548

(51) Int. Cl. G02B 5/28

(52) U.S. Cl. CPC G02B 5/28
USPC 359/578

(57) ABSTRACT

An optical filter device includes a wavelength variable interference filter provided with a movable substrate on which respective electrode pads are provided; a base substrate on which the wavelength variable interference filter is mounted, facing the movable substrate; and a fixing member that is disposed between the movable substrate and the base substrate and fixes the movable substrate and the base substrate. The fixing member is disposed at a position that overlaps the respective electrode pads, in a filter plan view.

### BACKGROUND

1. Technical Field

The present invention relates to an optical filter device, an optical module, and an electronic apparatus.

2. Related Art

In the related art, an interference filter in which reflecting films are respectively arranged to face each other through a predetermined gap, on a pair of substrates that faces each other, is known. Further, an optical filter device in which such an interference filter is accommodated in a housing is also known (for example, see JP-A-2008-70163 and JP-T-2005-510756).

JP-A-2008-70163 discloses an infrared gas detector (optical filter device) that includes a package (housing) having a plate-shaped base (base substrate) and a cylindrical cap. In the housing, a peripheral edge part of the base substrate and a cylindrical one end part of the cap are welded or adhered to each other, and a space for accommodating a Fabry-Perot filter (interference filter) is provided between the base substrate and the cap. Further, the interference filter is adhesively fixed to a detection section, and the detection section is adhesively fixed to the base of the can package.

JP-T-2005-510756 discloses filter device (photoelectric device) in which a tunable optical filter (interference filter) is fixed and accommodated inside a package (housing). In this optical filter device, the interference filter is disposed in a vertical stack mounted on an upper surface of a header (base substrate) of a housing.

As described above, in JP-A-2008-70163 and JP-T-2005-510756, there is only a mention that the interference filter is accommodated in and fixed to the housing, but a specific method thereof is not disclosed.

Here, there is a case where a drive electrode for changing the size of an inter-reflecting film gap or a charge removal electrode for removing electric charges of the reflecting films is provided in the interference filter. In a case where such an electrode is provided, due to a pressing force generated when wiring is performed with respect to the electrode, the interference filter may be inclined or bending may occur in the substrate, which affects an optical characteristic of the interference filter.

### SUMMARY

An advantage of some aspects of the invention is to provide an optical filter device, an optical module and an electronic apparatus capable of suppressing degradation of an optical characteristic.

An aspect of the invention is directed to an optical filter device including: an interference filter provided with a substrate on which a connection terminal is provided; a base substrate on which the interference filter is mounted, facing the substrate; and a fixing member that is disposed between the substrate and the base substrate, and fixes the substrate to the base substrate, in which the fixing member is disposed at a position that overlaps the connection terminal, in a plan view of the substrate and the base substrate, seen in a substrate thickness direction.

Here, in this aspect of the invention, the interference filter may have a configuration that includes at least the substrate; a first reflecting film that is provided on the substrate, reflects a part of an incident light and transmits at least apart thereof; and a second reflecting film that faces the first reflecting film, reflects a part of an incident light and transmits at least a part thereof.

Further, a configuration in which an electrode is provided on the substrate and the connection terminal is electrically connected to the electrode may be used.

In this aspect of the invention, when the substrate of the interference filter is fixed to the base substrate, the fixing member that fixes the substrate to the base substrate is arranged at the position that overlaps the connection terminal provided on the substrate, in the plan view of the substrate and the base substrate seen in the substrate thickness direction.

In such a configuration, since the fixing member is provided at the position that overlaps the connection terminal, even though the pressing force is applied to the connection terminal when a wire is connected to the connection terminal, it is possible to suppress inclination of the interference filter due to the pressing force.

In the optical filter device according to the aspect of the invention, it is preferable that the optical filter device further includes a housing that includes the base substrate and accommodates the interference filter fixed to the base substrate, and the housing includes a housing-side terminal that is electrically connected to the connection terminal by wire bonding.

According to this configuration, the connection terminal is electrically connected to the housing-side terminal by wire bonding. In the wire bonding, for example, the bonding is performed by retaining a wire in which a ball is formed at a tip thereof by a wire clamp and by pressing the wire clamp to the connection terminal that is a target to bring the ball in contact with the connection terminal. In such a wire bonding, even though the connection terminal is formed in a fine size, it is possible to connect the wire at a desired position with high accuracy. On the other hand, when the wire clamp is pressed to the connection terminal, the pressing force is applied to the interference filter, but as described above, since the fixing member is provided at the position that overlaps the connection terminal in the plan view, it is possible to suppress inclination of the interference filter and warp and bending of the substrate due to the pressing force.

In the optical filter device according to the aspect of the invention, it is preferable that a plurality of the connection terminals are provided and the connection terminals are arranged in one direction, and that the fixing member be arranged over the plurality of the connection terminals in a plan view.

According to this configuration, the fixing member is arranged over the plurality of the connection terminals in the plan view.

Thus, it is possible to fix the substrate to the base substrate by arranging one fixing member with respect to the plural connection terminals, and it is thus possible to simplify a manufacturing process.

In the optical filter device according to the aspect of the invention, it is preferable that a plurality of the connection terminals are provided, and the fixing member is individually disposed at a position that overlaps each of the plurality of the connection terminals in a plan view.

According to this configuration, the fixing member is individually arranged at the position that overlaps each of the plural connection terminals in the plan view.

Thus, it is possible to reduce a fixing area of the fixing member while maintaining the above-mentioned inclination suppression effect, and it is thus possible to reduce stress due to a difference of thermal expansion coefficients or contraction stress when an adhesive agent is cured. Thus, it is possible to suppress the influence of the stress on the substrate, and to suppress warpage of the substrate.

In the optical filter device according to the aspect of the invention, it is preferable that the substrate includes a terminal installation section that has a terminal installation region having an approximately rectangular appearance, in which the connection terminal are disposed on one side of the rectangle, and the length of the terminal installation region in a first direction parallel to one side of the rectangle is 30% or less of the length of the terminal installation section.

According to this configuration, the terminal installation section is provided on one side of a rectangle in the substrate having an approximately rectangular shape, and the plurality of the connection terminals are provided in the first direction along the one side of the rectangle. Further, the length of the terminal installation region that is a region that overlaps the connection terminals in the first direction is 30% or less of the length of the terminal installation section in the first direction.

Thus, it is possible to reduce the fixing area of the fixing member while maintaining the above-mentioned inclination suppression effect, and it is thus possible to reliably reduce stress due to a difference of thermal expansion coefficients or contraction stress when an adhesive agent is cured. Thus, it is possible to suppress the influence of the stress on the substrate.

In the optical filter device according to the aspect of the invention, it is preferable that the fixing member is an Ag paste.

When the interference filter is accommodated in the housing, by reducing the pressure to be equal to or lower than the atmospheric pressure inside the housing, it is possible to effectively suppress degradation of the reflecting films due to gas or the like contained in the atmosphere, or adhesion of foreign substances. In this case, by using the Ag paste for the fixing member, it is possible to suppress generation of outgas (degasification) from the fixing member, and it is thus possible to reliably maintain the inside of the housing in a vacuum state.

Another aspect of the invention is directed to an optical module including: an interference filter provided with a substrate on which a connection terminal is provided; a base substrate on which the interference filter is mounted, facing the substrate; a fixing member that is disposed between the substrate and the base substrate, and fixes the substrate to the base substrate; and a detection section that detects light extracted by the interference filter, in which the fixing member is disposed at a position that overlaps the connection terminal, in a plan view of the substrate and the base substrate, seen in a substrate thickness direction.

In this aspect of the invention, similar to the above aspect of the invention, since the fixing member is provided at the position that overlaps the connection terminal, even though a pressing force is applied to the connection terminal when a wire is connected to the connection terminal, it is possible to suppress inclination of the interference filter due to the pressing force, and thus, to reliably provide an optical module having a desired performance.

Still another aspect of the invention is directed to an electronic apparatus including: an interference filter provided with a substrate on which a connection terminal is provided; a base substrate on which the interference filter is mounted, facing the substrate; a fixing member that is disposed between the substrate and the base substrate, and fixes the substrate to the base substrate; and a control section that controls the interference filter, in which the fixing member is disposed at a position that overlaps the connection terminal, in a plan view of the substrate and the base substrate, seen in a substrate thickness direction.

In this aspect of the invention, similar to the above aspect of the invention, since the fixing member is provided at the position that overlaps the connection terminal, even though a pressing force is applied to the connection terminal when a wire is connected to the connection terminal, it is possible to suppress inclination of the interference filter due to the pressing force, and thus, to reliably provide an electronic apparatus having a desired performance.

### BRIEF DESCRIPTION OF THE DRAWINGS

The invention will be described with reference to the accompanying drawings, wherein like numbers reference like elements.

FIG. 1 is a perspective view schematically illustrating a configuration of an optical filter device according to a first embodiment of the invention.

FIG. 2 is a cross-sectional view schematically illustrating a configuration of the optical filter device according to the first embodiment.

FIG. 3 is a plan view schematically illustrating a configuration of a wavelength variable interference filter according to the first embodiment.

FIG. 4 is a cross-sectional view schematically illustrating the wavelength variable interference filter according to the first embodiment.

FIG. 5 is a diagram illustrating a position of a fixing member according to the first embodiment.

FIG. 6 is a process diagram illustrating a manufacturing process of the optical filter device according to the first embodiment.

FIG. 7 is a diagram illustrating a position of a fixing member according to a second embodiment of the invention.

FIG. 8 is a block diagram schematically illustrating a configuration of a color measurement apparatus according to a third embodiment of the invention.

FIG. 9 is a plan view schematically illustrating a configuration of a wavelength variable interference filter provided on a base substrate, in a modification example of an optical filter device according to the invention.

FIG. 10 is a diagram schematically illustrating a gas detector that is an example of an electronic apparatus according to the invention.

FIG. 11 is a block diagram illustrating a configuration of a control system of the gas detector in FIG. 10.

FIG. 12 is a diagram schematically illustrating a plant analysis apparatus that is an example of the electronic apparatus according to the invention.

FIG. 13 is a diagram schematically illustrating a configuration of a spectroscopic camera that is an example of the electronic apparatus according to the invention.

### DESCRIPTION OF EXEMPLARY EMBODIMENTS

### First Embodiment

Hereinafter, a first embodiment of the invention will be described with reference to the accompanying drawings.

### Configuration of Optical Filter Device

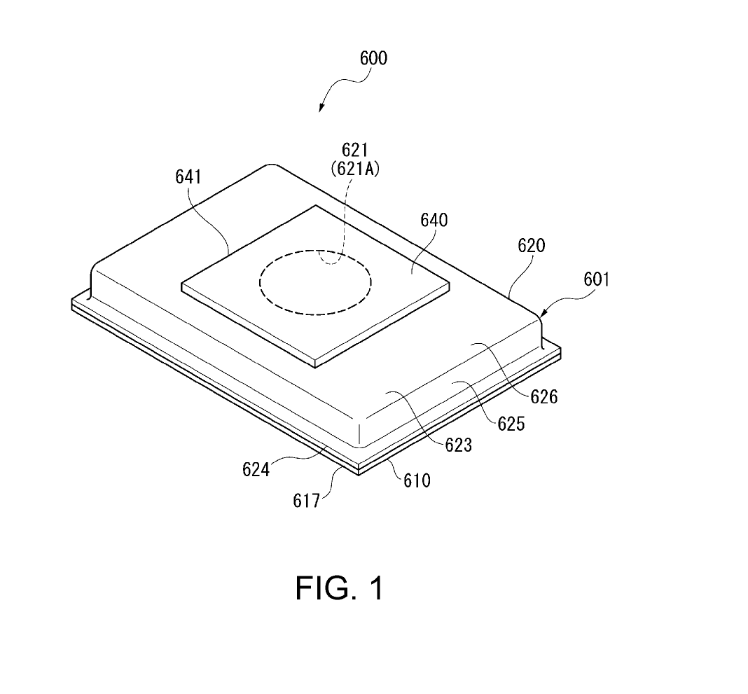

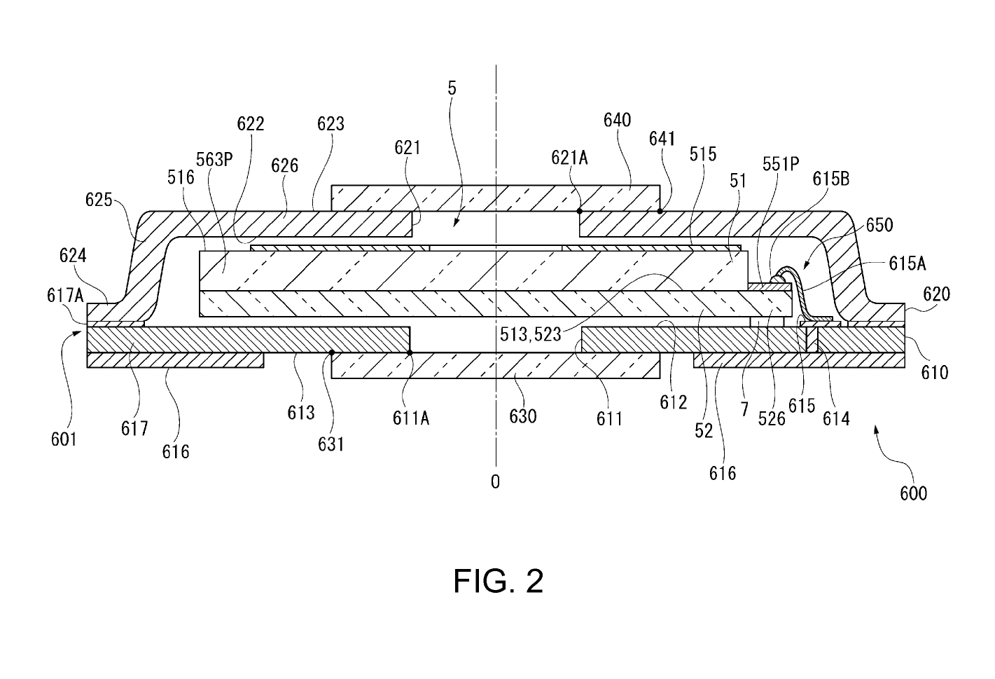

FIG. 1 is a perspective view schematically illustrating a configuration of an optical filter device 600 according to the first embodiment of the invention. FIG. 2 is a cross-sectional view of the optical filter device 600.

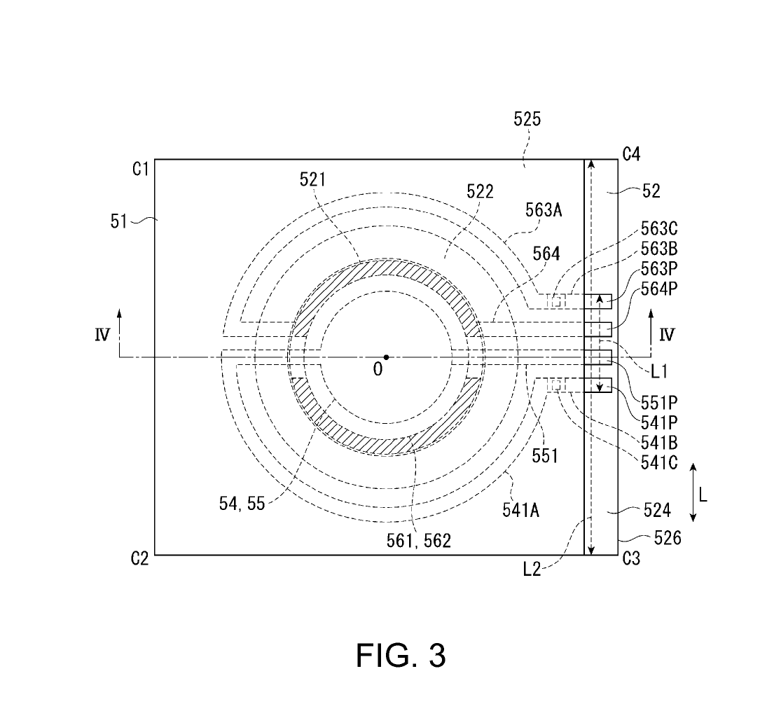

The optical filter device 600 is a device that extracts a light of a predetermined desired wavelength from an input test target light and outputs the extracted light, which includes a housing 601 and a wavelength variable interference filter 5 (see FIGS. 2 and 3) accommodated in the housing 601. The optical filter device 600 may be assembled in an optical module such as a color measuring sensor, or in an electronic apparatus such as a color measurement apparatus or a gas analysis apparatus. A configuration of the optical module or the electronic apparatus provided with the optical filter device 600 will be described in a third embodiment, to be described later.

### Configuration of Wavelength Variable Interference Filter

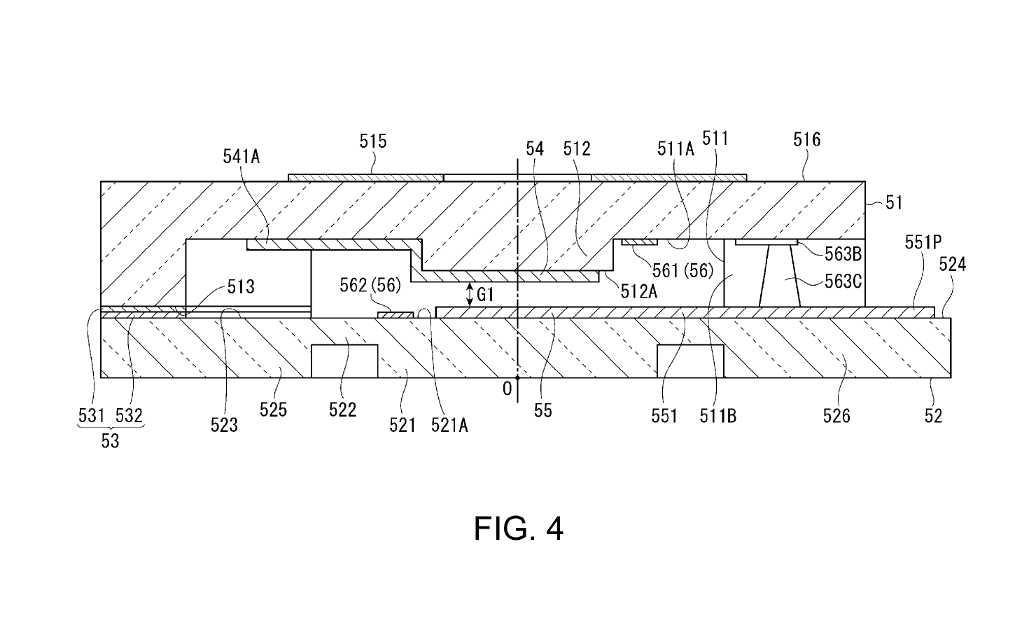

The wavelength variable interference filter 5 forms an interference filter according to the invention. FIG. 3 is a plan view schematically illustrating a configuration of the wavelength variable interference filter 5 provided in the optical filter device 600. FIG. 4 is a cross-sectional view schematically illustrating the configuration of the wavelength variable interference filter 5 taken along line IV-IV in FIG. 3.

As shown in FIG. 3, the wavelength variable interference filter 5 is an optical member of a rectangular shape, for example. The wavelength variable interference filter 5 includes a stationary substrate 51 and a movable substrate 52 that is a substrate according to the invention. The stationary substrate 51 and the movable substrate 52 are respectively formed of a variety of types of glass such as soda glass, crystalline glass, quartz glass, lead glass, potassium glass, borosilicate glass or alkali-free glass or a quartz crystal. Further, the stationary substrate 51 and the movable substrate 52 are integrally formed as a first bonding section 513 of the stationary substrate 51 and a second bonding section 523 of the movable substrate are bonded to each other by a bonding film 53 (a first bonding film 531 and a second bonding film 532) formed by a plasma polymerized film in which siloxane is a main component, for example.

In the following description, a plan view seen in a thickness direction of the stationary substrate 51 and the movable substrate 52, that is, a plan view of the wavelength variable interference filter 5, seen in a layering direction of the stationary substrate 51, the bonding film 53 and the movable substrate 52, is referred to as a filter plan view.

As shown in FIG. 4, a stationary reflecting film 54 (corresponding to a second reflective film) is provided on the stationary substrate 51. Further, a movable reflecting film 55 (corresponding to a first reflecting film) is provided on the movable substrate 52. The stationary reflecting film 54 and the movable reflecting film 55 are arranged to face each other through an inter-reflecting film gap G1.

Further, an electrostatic actuator 56 used for adjusting the distance (size) of the inter-reflecting film gap G1 is provided in the wavelength variable interference filter 5. The electrostatic actuator 56 includes a fixed electrode 561 provided on the stationary substrate 51 and a movable electrode 562 provided on the movable substrate 52, in which the electrodes 561 and 562 are formed to be opposite to each other (a region indicated by slant lines in FIG. 3). The fixed electrode 561 and the movable electrode 562 are opposite to each other through an inter-electrode gap. Here, the electrodes 561 and 562 may be directly provided to surfaces of the stationary substrate 51 and the movable substrate 52, respectively, or may be provided through a different film member.

In the present embodiment, a configuration is shown in which the inter-reflecting film gap G1 is formed to be smaller than the inter-electrode gap, but for example, the inter-reflecting film gap G1 may be formed to be larger than the inter-electrode gap according to a wavelength region that is transmitted by the wavelength variable interference filter 5.

In the filter plan view, one side (for example, a side C3-C4 in FIG. 3) of sides of the movable substrate 52 protrudes outward from the stationary substrate 51. The protruding portion of the movable substrate 52 is a non-bonding section 526 that is not bonded to the stationary substrate 51. In the non-bonding section 526 of the movable substrate 52, a surface thereof exposed when viewing the wavelength variable interference filter 5 from the side of the stationary substrate 51 forms an electrical installation surface 524 corresponding to a terminal installation section according to the invention.

### Configuration of Stationary Substrate

The stationary substrate 51 is formed by processing a glass base material formed in a thickness of 500 μm, for example. Specifically, as shown in FIG. 4, an electrode arrangement groove 511 and a reflecting film installation section 512 are formed in the stationary substrate 51 by an etching process. The stationary substrate 51 is formed to be larger than the movable substrate 52 in a thickness size, and thus, electrostatic attraction when a voltage is applied between the fixed electrode 561 and the movable electrode 562 or bending of the stationary substrate 51 due to internal stress of the fixed electrode 561 does not occur.

The electrode arrangement groove 511 is formed in an annular shape around a plane center point O of the wavelength variable interference filter 5 in the filter plan view. The reflecting film installation section 512 protrudes from a central part of the electrode arrangement groove 511 in the plan view toward the movable substrate 52, as shown in FIG. 4. Here, a groove bottom surface of the electrode arrangement groove 511 serves as an electrode installation surface 511A on which the fixed electrode 561 is disposed. Further, a protruding tip surface of the reflecting film installation section 512 serves as a reflecting film installation surface 512A.

Further, an electrode extraction groove 511B that extends toward the electrical installation surface 524 from the electrode arrangement groove 511 is provided in the stationary substrate 51.

On the electrode installation surface 511A of the electrode arrangement groove 511, the fixed electrode 561 is provided around the reflecting film installation section 512. The fixed electrode 561 is provided in a region that is opposite to the movable electrode 562 of a movable section 521, to be described later, on the electrode installation surface 511A, and is approximately formed in a “C” shape having an opening toward a side C1-C2 shown in FIG. 3. Further, a configuration in which an insulating film for securing an insulation characteristic between the fixed electrode 561 and the movable electrode 562 is layered on the fixed electrode 561 may be used.

Further, a fixed extraction electrode 563A that extends toward a side between apex C3 and apex C4 shown in FIG. 3 from a peripheral edge in the vicinity of the opening of the “C” shape of the fixed electrode 561 is provided on the stationary substrate 51. An extended tip portion (a part positioned on the side C3-C4 of the stationary substrate 51) of the fixed extraction electrode 563A is electrically connected to a fixed connection electrode 563B provided on the side of the movable substrate 52 through a bump electrode 563C. The fixed connection electrode 563B extends up to the electrical installation surface 524 through the electrode extraction groove 511B, and forms a fixed electrode pad 563P corresponding to a connection terminal according to the invention on the electrical installation surface 524. The fixed electrode pad 563P is connected to an internal terminal 615 provided on a base substrate 610, to be described later.

In the present embodiment, a configuration in which one fixed electrode 561 is provided on the electrode installation surface 511A is shown, but for example, a configuration in which two concentric electrodes are provided around the plane center point O may be used (a double electrode configuration).

As described above, the reflecting film installation section 512 includes the reflecting film installation surface 512A that is formed in an approximately cylindrical shape having a diameter size smaller than the electrode arrangement groove 511 on the same axis as in the electrode arrangement groove 511 and faces the movable substrate 52 of the reflecting film installation section 512.

As shown in FIG. 4, the stationary reflecting film 54 is provided on the reflecting film installation section 512. As the stationary reflecting film 54, for example, a metal film made of Ag or the like, or an alloy film made of an Ag alloy or the like may be used. Further, a dielectric multilayer in which a high refractive layer is made of TiO₂ and a low refractive layer is made of SiO₂ may be used. Further, a reflecting film in which a metal film (or an alloy film) is layered on a dielectric multilayer, a reflecting film in which a dielectric multilayer is layered on a metal film (or an ally film), a reflecting film in which a single refractive layer (made of TiO₂, SiO₂ or the like) and a metal layer (or an alloy layer) are layered, or the like may be used.

Further, the stationary substrate 51 includes a fixed mirror electrode 541A that is connected to the stationary reflecting film 54, extends toward the side C1-C2 through the opening of the “C” shape of the fixed electrode 561, and then extends toward the side C3-C4. The fixed mirror electrode 541A may be formed simultaneously with the stationary reflecting film 54 when the stationary reflecting film 54 is formed by a metal film made of an Ag alloy or the like.

An extended tip portion (a part positioned on the side C3-C4 of the stationary substrate 51) of the fixed mirror electrode 541A is electrically connected to a fixed mirror connection electrode 541B provided on the movable substrate 52 through a bump electrode 541C. The fixed mirror connection electrode 541B extends up to the electrical installation surface 524 through the electrode extraction groove 511B, and forms a fixed mirror electrode pad 541P corresponding to a connection terminal according to the invention on the electrical installation surface 524. The fixed mirror electrode pad 541P is connected to the internal terminal 615 provided on the base substrate 610, to be described later, and is connected to a ground circuit (not shown). Thus, the stationary reflecting film 54 is set to a ground potential (0V).

Further, a surface of the stationary substrate 51 on which the stationary reflecting film 54 is not provided is a light incident surface 516, as shown in FIG. 4. An antireflection film may be formed on the light incident surface 516 at a position corresponding to the stationary reflecting film 54. The antireflection film may be formed by alternately layering a low refractive index film and a high refractive index film, to decrease a reflectance of visible light on the surface of the stationary substrate 51 and to increase transmittance.

Further, as shown in FIG. 4, a non-light transmissive member 515 formed of Cr or the like is provided on the light incident surface 516 of the stationary substrate 51 (in FIG. 3, the non-light transmissive member 515 is not shown). The non-light transmissive member 515 is formed in an annular shape, and is formed preferably in a ring shape. Further, an inner diameter of the non-light transmissive member 515 is set to an effective diameter for light interference in the stationary reflecting film 54 and the movable reflecting film 55. Thus, the non-light transmissive member 515 functions as an aperture that condenses incident light incident onto the optical filter device 600.

Further, in the surface of the stationary substrate 51 that faces the movable substrate 52, a surface in which the electrode arrangement groove 511, the reflecting film installation section 512 and the electrode extraction groove 511B are not formed by the etching process forms the first bonding section 513. The first bonding film 531 is provided on the first bonding section 513. As the first bonding film 531 is bonded to the second bonding film 532 provided on the movable substrate 52, the stationary substrate 51 and the movable substrate 52 are bonded to each other, as described above.

### Configuration of Movable Substrate

The movable substrate 52 is formed by processing a glass base material formed in a thickness of 200 μm, for example.

Specifically, as shown in FIG. 3, the movable substrate 52 includes the movable section 521 of a circular shape disposed around the plane center point O in the filter plan view; a holding section 522 that is provided outside the movable section 521 and holds the movable section 521; and a substrate peripheral section 525 provided outside the holding section 522.

The movable section 521 is formed to be larger than the holding section 522 in a thickness size. For example, in the present embodiment, the movable section 521 is formed to be the same as the thickness size of the movable substrate 52. The diameter size of the movable section 521 is formed at least to be larger than the diameter size of the outer periphery of the reflecting film installation surface 512A, in the filter plan view. Further, the movable electrode 562 and the movable reflecting film 55 are provided on the movable section 521.

Similarly to the stationary substrate 51, on a surface of the movable section 521 opposite to the stationary substrate 51, an antireflection film may be formed. Such an antireflection film may be formed by layering alternately a low refractive index film and a high refractive index film, to decrease the reflectance of the visible light on the surface of the movable substrate 52 and to increase the transmittance. Further, in the present embodiment, the surface of the movable section 521 that faces the stationary substrate 51 is a movable surface 521A.

The movable electrode 562 faces the fixed electrode 561 through the inter-electrode gap, and is approximately formed in a “C” shape having an opening toward the side C3-C4 shown in FIG. 3 at a position that faces the fixed electrode 561. Further, a movable extraction electrode 564 that extends toward the electrical installation surface 524 from a peripheral edge in the vicinity of the opening of the “C” shape of the movable electrode 562 is provided on the movable substrate 52. An extended tip portion of the movable extraction electrode 564 forms a movable electrode pad 564P corresponding to a connection terminal according to the invention on the electrical installation surface 524. The movable electrode pad 564P is connected to the internal terminal 615 provided on the base substrate 610 to be described later.

As shown in FIG. 4, the movable reflecting film 55 is provided to face the stationary reflecting film 54 through the inter-reflecting film gap G1 at the central part of the movable surface 521A of the movable section 521. As the movable reflecting film 55, a reflecting film having the same configuration as that of the stationary reflecting film. 54 may be used.

Similarly to the fixed mirror electrode 541A, the movable substrate 52 includes a movable mirror electrode 551 that is connected to the movable reflecting film 55 and extends toward the electrical installation surface 524 through the opening of the “C” shape of the movable electrode 562. An extended tip portion of the movable mirror electrode 551 forms a movable mirror electrode pad 551P corresponding to a connection terminal according to the invention on the electrical installation surface 524. The movable mirror electrode pad 551P is connected to the internal terminal 615 provided on the base substrate 610, to be described later, and is connected to the ground circuit (not shown), similarly to the fixed mirror electrode pad 541P. Thus, the movable reflecting film 55 is set to the ground potential (0V).

The holding section 522 is a diaphragm that surrounds the movable section 521, which is formed to be smaller than the movable section 521 in a thickness size.

The holding section 522 is easily bent compared with the movable section 521, and enables the movable section 521 to be displaced toward the stationary substrate 51 by slight electrostatic attraction. Here, the thickness size of the movable section 521 is larger than the thickness size of the holding section 522, and thus, its rigidity increases. Thus, even when the holding section 522 is pulled toward the stationary substrate 51 due to the electrostatic attraction, the shape of the movable section 521 is not changed. Accordingly, it is possible to constantly maintain the stationary reflecting film 54 and the movable reflecting film in a parallel state, without bending of the movable reflecting film 55 provided on the movable section 521.

In the present embodiment, the diaphragm-shaped holding section 522 is shown, but the invention is not limited thereto. For example, a configuration may be used in which beam-shaped holding sections arranged at equal angular intervals are provided around the plane center point O.

As described above, the substrate peripheral section 525 is provided outside the holding section 522 in the filter plan view. A surface of the substrate peripheral section 525 that faces the stationary substrate 51 includes the second bonding section 523 that faces the first bonding section 513. Further, the second bonding film 532 is provided on the second bonding section 523, and as described above, as the second bonding film 532 is bonded to the first bonding film 531, the stationary substrate 51 and the movable substrate 52 are bonded to each other.

### Configuration of Housing

Returning to FIGS. 1 and 2, the housing 601 includes the base substrate 610, a lid 620, a base-side glass substrate 630 (light transmission substrate), and a lid-side glass substrate 640 (light transmission substrate).

The base substrate 610 is formed by a single layer ceramic substrate, for example. The movable substrate 52 of the wavelength variable interference filter 5 is provided on the base substrate 610.

The movable substrate 52 is fixed to the base substrate 610 by a fixing member 7 disposed between the movable substrate 52 and the base substrate 610.

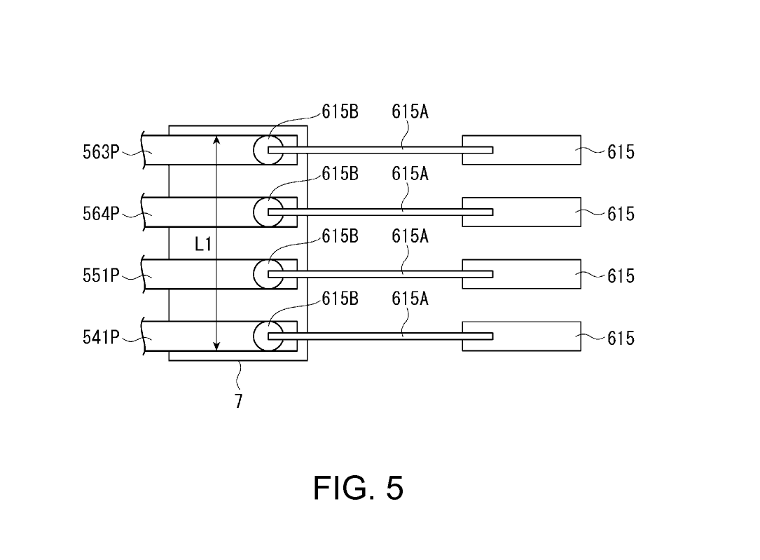

FIG. 5 is a diagram illustrating a positional relationship between electrode pads 541P, 551P, 563P and 564P and the fixing member 7 when a region (terminal installation region) where the electrode pads 541P, 551P, 563P and 564P on the electrical installation surface 524 of the movable substrate 52 are provided is seen from the side of the stationary substrate 51.

As shown in FIG. 5, the fixing member 7 is disposed in a region that overlaps a region where the electrode pads 541P, 551P, 563P and 564P are arranged, over the electrode pads 541P, 551P, 563P and 564P in the filter plan view. In FIG. 5, the fixing member 7 is disposed in a region slightly larger than a region that overlaps the electrode pads 541P, 551P, 563P and 564P.

As the fixing member 7, an Ag paste with small degasification (gas discharge) is used to maintain an internal space 650 in a vacuum state. Here, the fixing member 7 is not limited to the Ag paste, and any member capable of fixing the movable substrate 52 and the base substrate 610 may be used. For example, an epoxy adhesive or a silicon adhesive may be used.

The fixing member 7 may be a member that physically engages or fits the movable substrate 52 with the base substrate 610, for example.

It is preferable that a size L1 of the terminal installation region of the electrical installation surface 524 in a length direction L (that is, a direction parallel to the side C3-C4 of the movable substrate 52) be 30% or less of a size L2 of the electrical installation surface (see FIG. 3).

For example, when each size of the electrode pads 541P, 551P, 563P and 564P is 0.2 mm and each interval between the electrode pads 541P, 551P, 563P and 564P is 0.4 mm, the size L1 of the terminal installation region is about 2.0 mm. On the other hand, the size L2 of the electrical installation surface 524 (that is, the size of one side of the movable substrate 52) is about 10 mm, for example. In this case, the size L1 of the terminal installation region is 20% of the size L2 of the electrical installation surface.

The present inventors manufactured an optical filter device in which the size of the terminal installation region in the length direction L is set to 35% of the size L2 of the electrical installation surface 524, and performed experiments before and after each electrode pad is connected to the internal terminal. Consequently, the present inventors obtained a result that a half-value width that is an index of a spectral characteristic is two times after the connection compared with before the connection. On the basis of the experiment result, it can be understood that it is preferable that the size of the installation region in the length direction L be 30% or less of the size L2 of the electrical installation surface 524.

In the base substrate 610, a light passage hole 611 is formed in a region that faces the reflecting films (the stationary reflecting film 54 and the movable reflecting film 55) of the wavelength variable interference filter 5.

On a base inner surface 612 (lid facing surface) of the base substrate 610 that faces the lid 620, four internal terminals 615 that are individually connected to the electrode pads 541P, 551P, 563P and 564P on the electrical installation surface 524 of the wavelength variable interference filter 5 are provided.

The electrode pads 541P, 551P, 563P and 564P and the internal terminals 615 are connected by wire bonding, for example, using a wire 615A made of Au or the like.

Further, in the base substrate 610, a through hole 614 is formed corresponding to a position where each internal terminal 615 is provided. Each internal terminal 615 is connected to each external terminal section 616 provided on a base outer surface 613 opposite to the base inner surface 612 of the base substrate 610, through the through hole 614. Here, a metal member (for example, an Ag paste or the like) that connects the internal terminal 615 and the external terminal section 616 is filled in the through hole 614, so that air tightness of the internal space 650 of the housing 601 is maintained.

Further, in an outer peripheral section of the base substrate 610, a base bonding section 617 connected to the lid 620 is formed.

As shown in FIGS. 1 and 2, the lid 620 includes a lid bonding section 624 bonded to the base bonding section 617 of the base substrate 610, a sidewall section 625 that is continuous from the lid bonding section 624 and stands up in a direction separating from the base substrate 610, and a top surface section 626 that is continuous from the sidewall section 625 and covers the stationary substrate 51 of the wavelength variable interference filter 5. The lid 620 may be formed of an alloy of Kovar or the like, or a metal, for example.

The lid 620 is closely bonded to the base substrate 610 as the lid bonding section 624 and the base bonding section 617 of the base substrate 610 are bonded to each other.

As a bonding method, for example, laser welding, soldering with brazing silver or the like, sealing with a eutectic alloy layer, welding with a low melting point glass, glass adhesion, glass frit bonding, adhesion using epoxy resin, or the like may be used. These bonding methods may be appropriately selected according to materials of the base substrate 610 and the lid 620, a bonding environment and the like.

In the present embodiment, on the base bonding section 617 of the base substrate 610, for example, a bonding pattern 617A formed of Ni, Au or the like is formed. Further, the formed bonding pattern 617A and the lid bonding section 624 are irradiated with a high power laser (for example, a YAG laser or the like) for laser bonding.

The top surface section 626 of the lid 620 includes a lid inner surface 622 that is a surface of the inside of the lid 620 (on the side of the base substrate 610), and a lid outer surface 623 that is a surface of the outside thereof, which are parallel to the base substrate 610. In the top surface section 626, a light passage hole 621 is formed in a region that faces the reflecting films 54 and 55 of the wavelength variable interference filter 5.

Here, in the present embodiment, light is incident through the light passage hole 621 of the lid 620, is extracted from the wavelength variable interference filter 5, and then, is output through the light passage hole 611 of the base substrate 610. In such a configuration, only light corresponding to the effective diameter of the non-light transmissive member 515 provided on the light incident surface 516 of the wavelength variable interference filter 5 is incident onto the stationary reflecting film 54 and the movable reflecting film 55. In particular, the substrates 51 and 52 of the wavelength variable interference filter 5 are shape-formed by the etching process, in which an etched part is formed as a curved surface section due to the influence of side etching. If light is incident onto the curved surface section, the light may become stray light to be output through the light passage hole 611. On the other hand, in the present embodiment, it is possible to prevent the occurrence of the stray light by the non-light transmissive member 515, and to extract light of a desired wavelength.

The base-side glass substrate 630 is a glass substrate bonded to the base outer surface 613 of the base substrate 610 to cover the light passage hole 611. The base-side glass substrate 630 is formed to have a size larger than the light passage hole 611. The base-side glass substrate 630 is disposed so that a plane center point O thereof coincides with a plane center point O of the light passage hole 611. The plane center point O coincides with the plane center point O of the wavelength variable interference filter 5, and coincides with the plane center points O of annular inner peripheries of the stationary reflecting film 54, the movable reflecting film 55 and the non-light transmissive member 515. Further, the base-side glass substrate 630 is bonded to the base substrate 610 in a region outside an outer periphery 611A of the light passage hole 611 (in a region from the outer periphery 611A to a substrate edge 631 of the base-side glass substrate 630), in a plan view of the optical filter device 600 seen in the thickness direction of the base substrate 610 (base-side glass substrate 630).

The lid-side glass substrate 640 is a glass substrate bonded to the lid outer surface 623 of the lid 620 to cover the light passage hole 621. The lid-side glass substrate 640 is formed to have a size larger than the light passage hole 621. The lid-side glass substrate 640 is disposed so that a plane center point O thereof coincides with a plane center point O of the light passage hole 621. Further, the lid-side glass substrate 640 is bonded to the lid 620 in a region outside an outer periphery 621A of the light passage hole 621 (in a region from the outer periphery 621A to a substrate edge 641 of the lid-side glass substrate 640), in a plan view of the optical filter device 600 seen in the thickness direction of the base substrate 610 (lid-side glass substrate 640).

As a bonding method of the base substrate 610 and the base-side glass substrate 630, and the lid 620 and the lid-side glass substrate 640, for example, glass frit bonding using a glass frit, which is a scrap of glass obtained by melting the glass material at high temperature and then rapidly cooling the melted material, may be used. In the glass frit bonding, by using the glass frit with small degasification (gas discharge) and with no generation of a gap in the bonding section, it is possible to maintain the internal space 650 in a vacuum state. The bonding is not limited to the glass frit bonding, and bonding such as welding using a low melting point glass, or bonding using glass sealing may be performed. Further, although not suitable for the maintenance of the vacuum state of the internal space 650, in consideration of only for the purpose of suppressing intrusion of foreign matters into the internal space 650, adhesion using epoxy resin or the like may be performed.

As described above, in the optical filter device 600 of the present embodiment, the housing 601 is configured so that the internal space 650 of the housing 601 is air-tightly maintained by the bonding of the base substrate 610 and the lid 620, the bonding of the base substrate 610 and the base-side glass substrate 630, and the bonding of the lid 620 and the lid-side glass substrate 640. Further, in the present embodiment, the internal space 650 is maintained in the vacuum state.

In this way, by maintaining the internal space 650 in the vacuum state, when the movable section 521 of the wavelength variable interference filter 5 is moved, it is possible to achieve excellent responsiveness without generation of air resistance.

### Manufacturing Method of Optical Filter Device

Next, a manufacturing method of the above-described optical filter device 600 will be described with reference to the accompanying drawings.

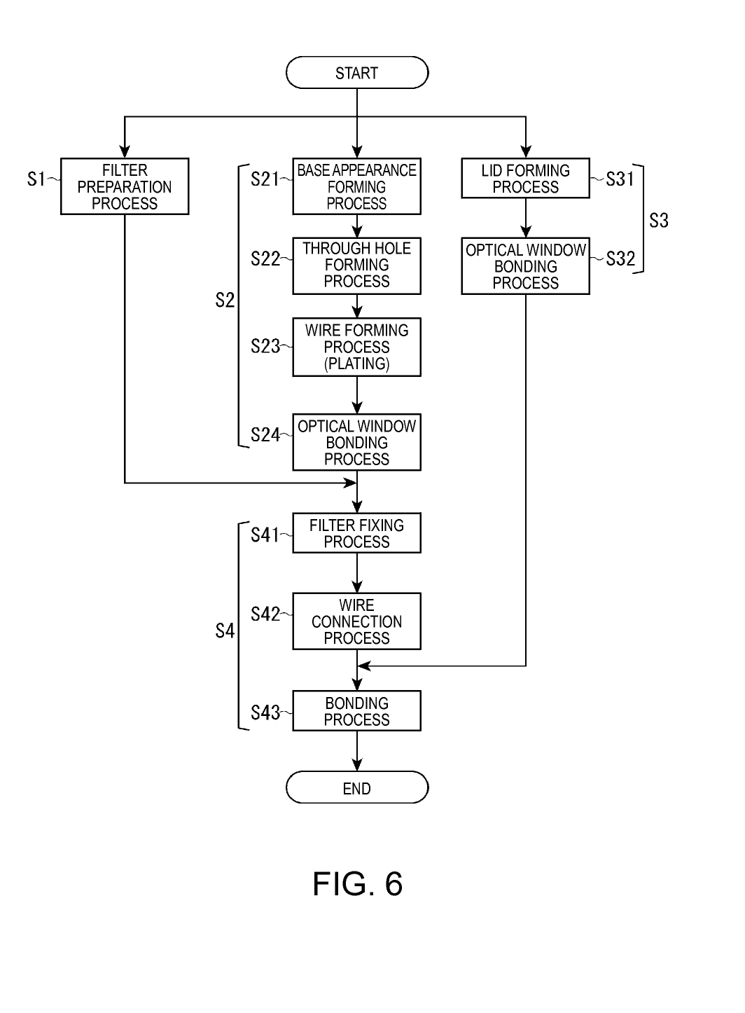

FIG. 6 is a process diagram illustrating a manufacturing process of manufacturing the optical filter device 600.

In manufacturing of the optical filter device 600, first, a filter preparation process (S1) of manufacturing the wavelength variable interference filter 5 that forms the optical filter device 600, a base substrate preparation process (S2) and a lid preparation process (S3) are respectively performed.

### Filter Preparation Process

In the filter preparation process (S1), first, the wavelength variable interference filter 5 is manufactured.

In the filter preparation process S1, the stationary substrate 51 and the movable substrate 52 are formed by an appropriate etching process, or the like. Further, with respect to the stationary substrate 51, the fixed electrode 561 and the fixed extraction electrode 563A are formed, the non-light transmissive member 515 is formed, and then, the stationary reflecting film 54 is formed. Further, with respect to the movable substrate 52, the movable electrode 562 is formed, and then, the movable reflecting film 55 is formed.

Then, the stationary substrate 51 and the movable substrate 52 are bonded to each other through the bonding film 53, to obtain the wavelength variable interference filter 5. Further, the stationary substrate 51 and the movable substrate 52 are bonded to each other to form the non-bonding section 526.

### Base Substrate Preparation Process

In the base substrate preparation process (S2), first, a base appearance forming process is performed (S21). In S21, a substrate before baking in which sheets that are materials for forming a ceramic substrate are layered is appropriately cut, for example, to form the shape of the base substrate 610 having the light passage hole 611. Then, the substrate before baking is baked, to form the base substrate 610.

The light passage hole 611 may be formed by processing the baked base substrate 610 using a high power laser such as a YAG laser.

Then, a through hole forming process of forming the through hole 614 in the base substrate 610 is performed (S22). In S22, a laser process using a YAG laser or the like is performed, for example, to form the fine through hole 614. Further, a conductive member with a high adhesion property to the base substrate 610 is filled in the formed through hole 614.

Then, a wire forming process of forming the internal terminals 615 and the external terminal section 616 on the base substrate 610 is performed (S23).

In S23, for example, a plating process using a metal such as Ni/Au is performed to form the internal terminals 615 and the external terminal section 616. Further, if the base bonding section 617 and the lid bonding section 624 are bonded to each other by laser beam welding, plating with Ni or the like is performed on the base bonding section 617 to form the bonding pattern 617A.

Then, an optical window bonding process of bonding the base-side glass substrate 630 that covers the light passage hole 611 onto the base substrate 610 is performed (S24).

In S24, alignment adjustment is performed so that the plane center of the base-side glass substrate 630 and the plane center of the light passage hole 611 coincide with each other, and then, the base-side glass substrate 630 is bonded to the base substrate 610 by frit glass bonding using the frit glass.

### Lid Preparation Process

In the lid preparation process (S3), first, a lid forming process of forming the lid 620 is performed (S31). In S31, a metal substrate formed of Kovar or the like is processed by press working, to form the lid 620 having the light passage hole 621.

Then, an optical window bonding process of bonding the lid-side glass substrate 640 that covers the light passage hole 621 onto the lid 620 is performed (S32).

In S32, alignment adjustment is performed so that the plane center of the lid-side glass substrate 640 and the plane center of the light passage hole 621 coincide with each other, and then, the lid-side glass substrate 640 is bonded to the lid 620 by frit glass bonding using the frit glass.

### Device Assembly Process

Next, a device assembly process of bonding the wavelength variable interference filter 5, the base substrate 610 and the lid 620 obtained in the processes of S1 to S3 to form the optical filter device 600 is performed (S4).

In S4, first, a filter fixing process of fixing the wavelength variable interference filter 5 to the base substrate 610 by the fixing member 7 is performed (S41). In the present embodiment, as described above, at the position shown in FIGS. 2 and 3, the substrate peripheral section 525 of the movable substrate 52 is fixed to the base substrate 610 using the fixing member 7. Ag paste is used as the fixing member 7, in the present embodiment. The fixing member is arranged at the position that overlaps the terminal installation region of the base substrate 610 in the filter plan view. Further, alignment adjustment is performed so that the plane center points O of the stationary reflecting film 54 and the movable reflecting film 55 coincide with the plane center point O of the light passage hole 611. After the alignment adjustment, the movable substrate 52 is attached to the base substrate 610, and then, the Ag paste is cured. In this way, the wavelength variable interference filter 5 is fixed to the base substrate 610.

Then, a wire connection process is performed (S42). In S42, the electrode pads 541P, 551P, 563P and 564P of the wavelength variable interference filter 5 and the internal terminals 615 are connected to each other by the wire 615A, respectively, by wire bonding. That is, a wire is inserted into a capillary, and then, a free air ball (FAB) is formed at the tip of the wire 615A. In this state, the capillary is moved to contact the ball with the fixed electrode pad 563P, to form a bond 615B. Further, the capillary is moved to connect the wire to the internal terminal 615, and then, the wire is cut. The same connection process is performed for the other electrode pads 541P, 551P and 564P.

As the wire bonding, an example in which the connection is performed using the ball bonding is described, but a wedge bonding or the like may be used.

Then, a bonding process of bonding the base substrate 610 and the lid 620 is performed (S43). In S43, for example, in a vacuum chamber device or the like, the base substrate 610 and the lid 620 are overlapped in an environment set to a vacuum atmosphere, and then, the base substrate 610 and the lid 620 are bonded to each other by laser bonding using a YAG laser or the like, for example. In the laser bonding, since only a bonding section is locally changed to a high temperature for bonding, it is possible to suppress a temperature increase of the internal space 650. Accordingly, it is possible to prevent a disadvantage of degradation of the reflecting films 54 and 55 of the wavelength variable interference filter 5 due to the high temperature.

As described above, the optical filter device 600 is manufactured.

### Effects of the First Embodiment

In the present embodiment, in the optical filter device 600, in the filter plan view, the fixing member 7 is arranged at the position that overlaps the terminal installation region where the electrode pads 541P, 551P, 563P and 564P of the wavelength variable interference filter 5 are provided.

In the optical filter device 600 having the above-described configuration, the electrode pads 541P, 551P, 563P and 564P provided on the movable substrate 52 are electrically connected to the internal terminals 615 provided on the base substrate 610 through the conductive member, using the wire bonding. When bonding the conductive member in this way, each of the electrode pads 541P, 551P, 563P and 564P is pressed by the capillary.

Here, if the fixing member 7 is provided at a position that does not overlap the terminal installation region where the electrode pads 541P, 551P, 563P and 564P are provided in the filter plan view, when the electrode pads 541P, 551P, 563P and 564P are pressed as described above, there is a concern that the wavelength variable interference filter 5 is inclined with respect to the base substrate 610 using the position where the fixing member 7 is provided as a supporting point.

On the other hand, according to the optical filter device 600 having the above-described configuration, the fixing member 7 is arranged at the position that overlaps the terminal installation region where the electrode pads 541P, 551P, 563P and 564P are provided, in the filter plan view. Thus, in the filter plan view, it is possible to arrange the fixing member 7 to overlap the pressing position, and it is thus possible to suppress the inclination of the wavelength variable interference filter 5 when pressed. Further, since it is possible to suppress the inclination of the wavelength variable interference filter 5, it is possible to arrange the wavelength variable interference filter 5 at a predetermined arrangement position, and to suppress degradation of spectral performance of the optical filter device 600.

Further, when performing the wire bonding, if the wavelength variable interference filter 5 is inclined, it is difficult to sufficiently press the electrode pads 541P, 551P, 563P and 564P by means of the capillary, and it is thus difficult to form the bond 615B having a desired bonding strength, which results in a concern that a bonding error occurs. On the other hand, in the optical filter device 600 of the present embodiment, since it is possible to suppress the inclination of the wavelength variable interference filter 5, it is possible to obtain a pressing force necessary for forming the bond 615B having the desired bonding strength, and to suppress the occurrence of the bonding error.

Further, if the wavelength variable interference filter 5 is inclined in bonding, there is a concern that the movable substrate 52 is separated from the fixing member 7 and the wavelength variable interference filter 5 fixed to the base substrate 610 is separated therefrom. On the other hand, in the optical filter device 600 of the present embodiment, since it is possible to suppress the inclination of the wavelength variable interference filter 5, it is possible to suppress the separation of the wavelength variable interference filter 5.

Further, in an optical filter device in which the fixing member 7 is arranged to overlap the entire surface between the movable substrate 52 and the base substrate 610 or is arranged at a position other than the position that overlaps the terminal installation position, stress due to a difference of thermal expansion coefficients of the movable substrate 52 and the fixing member 7 or a difference of thermal expansion coefficients of the base substrate 610 and the fixing member 7 easily acts over the entirety of the movable substrate 52. Further, similarly, when an adhesive is used as the fixing member 7, stress due to contraction in curing easily acts over the entirety of the movable substrate 52. Further, since the movable substrate 52 is bonded to the stationary substrate 51, stress also easily acts on the stationary substrate 51. If the stress acts, the stationary reflecting film 54 of the stationary substrate 51 or the movable reflecting film 55 of the movable substrate 52 is deformed, for example, inclined, warped or bent. Thus, there is a concern that the spectral performance of the wavelength variable interference filter 5 is reduced.

On the other hand, according to the optical filter device 600 having the above-described configuration, the fixing member 7 is arranged at the position that overlaps the terminal installation region in the filter plan view, and compared with a case where the fixing member 7 is arranged on the entire surface between the movable substrate 52 and the base substrate 610, the amount of the fixing member 7 and the fixing area thereof are reduced. Thus, it is possible to reduce the stress due to the difference of the thermal expansion coefficients or the contraction stress when the adhesive is cured, and to suppress the influence of the stress on the movable substrate 52 or the stationary substrate 51. Accordingly, it is possible to suppress the warpage of the movable substrate 52 or the stationary substrate 51, and to suppress the degradation of the spectral performance.

In the optical filter device 600, the electrode pads 541P, 551P, 563P and 564P are electrically connected to the internal terminals 615 by the wire bonding.

In this wire bonding, even when the connection terminal is formed in a fine size, it is possible to connect the wire to a desired position with high accuracy. On the other hand, when the capillary (wire clamp) is pressed to the electrode pads 541P, 551P, 563P and 564P, the pressing force is applied to the wavelength variable interference filter 5, but as described above, since the fixing member 7 is provided at the position that overlaps the electrode pads 541P, 551P, 563P and 564P in the filter plan view, it is possible to suppress inclination of the wavelength variable interference filter 5 or bending of the movable substrate 52 due to the pressing force.

In the optical filter device 600, the fixing member 7 is arranged over the plural electrode pads 541P, 551P, 563P and 564P provided in the terminal installation region, in the filter plan view. Thus, it is possible to fix the movable substrate 52 to the base substrate 610 by arranging one fixing member 7 with respect to the plural electrode pads 541P, 551P, 563P and 564P, and it is thus possible to simplify the manufacturing process.

In the optical filter device 600, the movable substrate 52 includes the terminal installation section that has the approximately rectangular appearance and allows the installation of the electrode pads 541P, 551P, 563P and 564P on one side of the rectangle. Further, the length, in the direction of the one side (first direction), of the terminal installation region where the electrode pads 541P, 551P, 563P and 564P are provided is set to 30% or less of the length of the terminal installation section.

Thus, it is possible to reduce the fixing area by means of the fixing member 7 while maintaining the above-described inclination suppression effect, and it is thus possible to reliably reduce the stress due to the difference of the thermal expansion coefficients or the contraction stress when the adhesive is cured, and to reliably suppress the influence of the stress on the movable substrate 52 or the stationary substrate 51. Accordingly, it is possible to reliably suppress the warpage of the substrates 51 and 52, and to reliably suppress the warpage of the reflecting films 54 and 55.

In the optical filter device 600, the movable substrate 52 includes the electrical installation surface 524 that has the approximately rectangular appearance, is exposed from the stationary substrate 51 on one side of the rectangle, and allows the installation of the electrode pads 541P, 551P, 563P and 564P. Further, in the length direction L of the electrical installation surface 524, the size L1 of the terminal installation region where the electrode pads 541P, 551P, 563P and 564P are provided is set to 30% or less than the size L2 of the electrical installation surface 524.

The stress from the fixing member 7 to the base substrate 610 and the movable substrate 52 is changed according to the amount of the fixing member 7 and the fixing area thereof (a contact area of the fixing member 7 and each of the substrates 52 and 610), and is increased as the amount of the fixing member 7 and the fixing area thereof are increased. A substrate interval of the movable substrate 52 and the base substrate 610 or the size of the electrical installation surface 524 in the direction of the short side is basically a predetermined value in design or the like, and thus, the amount of the fixing member 7 and the fixing area thereof are proportional to the size of the length direction L. Accordingly, by decreasing the size of the length direction L of the terminal installation region, it is possible to reduce the stress due to the difference of the thermal expansion coefficients or the contraction stress when the adhesive is cured.

In the optical filter device 600 having the above-describe configuration, by setting the size of the length direction L of the terminal installation region to 30% or less of the size L2 of the electrical installation surface 524, it is possible to reliably reduce the stress due to the difference of the thermal expansion coefficients or the contraction stress when the adhesive is cured, while maintaining the above-described inclination suppression effect, and thus, it is possible to reliably suppress the influence of the stress on the movable substrate 52 or the stationary substrate 51. Accordingly, it is possible to reliably suppress the warpage of the substrates 51 and 52, and to reliably suppress the warpage of the reflecting films 54 and 55.

In the optical filter device 600, since the wavelength variable interference filter 5 is accommodated in the housing 601, it is possible to suppress degradation of the reflecting films due to gas or the like contained in the atmosphere or adhesion of foreign substances.

Further, by reducing the pressure of the internal space 650 of the housing 601 to be equal to or lower than the atmospheric pressure, for example, it is possible to effectively suppress degradation of the reflecting films due to gas or the like contained in the atmosphere or adhesion of foreign substances. In this case, by using Ag paste as the fixing member 7, it is possible to suppress degasification due to the fixing member 7, and to reliably maintain the inside of the housing 601 in a decompression state.

### Second Embodiment

Next, a second embodiment of the invention will be described with reference to the accompanying drawings.

The second embodiment is different from the first embodiment in that a fixing member is individually arranged at a position that overlaps each of the electrode pads 541P, 551P, 563P and 564P in the filter plan view.

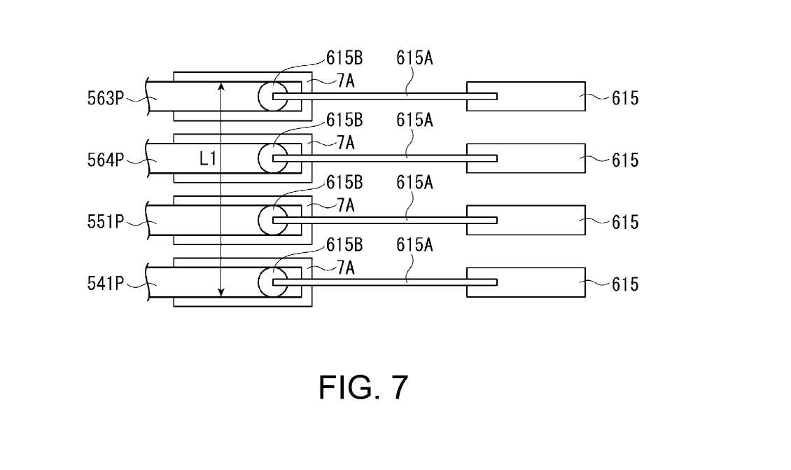

FIG. 7 is a diagram illustrating a positional relationship between each of the electrode pads 541P, 551P, 563P and 564P and fixing members 7A in the filter plan view, in an optical filter device according to the second embodiment of the invention. The second embodiment has basically the same configuration except for the above different point. In the following description of the present embodiment, the same reference numerals are given to the same components, and the description will not be repeated or simplified.

As shown in FIG. 7, the fixing members 7A are individually arranged at the position that overlaps each of the electrode pads 541P, 551P, 563P and 564P in the filter plan view. Similarly to the first embodiment, the fixing member 7A may be a member that physically engages or fits the movable substrate 52 with the base substrate 610.

In the present embodiment, a terminal installation region where the fixing member 7A is installed is a region that covers the entire fixing members 7A arranged in the length direction L.

In the present embodiment, it is preferable that the size L1 of the terminal installation region in the length direction L be equal to or less than 30% of the size L2 of the electrical installation surface.

### Effects of the Second Embodiment

In the present embodiment, in the filter plan view, the fixing members 7A are individually arranged at the position that overlaps each of the plural electrode pads 541P, 551P, 563P and 564P provided in the terminal installation region.

According to this configuration, it is possible to reduce the fixing area by each fixing member 7A while maintaining the above-described inclination suppression effect, and thus, it is possible to reduce the stress due to the difference of thermal expansion coefficients or the contraction stress when the adhesive is cured, and to reliably suppress the influence of the stress on the stationary substrate 51 or the movable substrate 52. Accordingly, it is possible to reliably suppress the warpage of the reflecting films 54 and 55.

### Third Embodiment

Next, a third embodiment of the invention will be described with reference to the accompanying drawings.

In the third embodiment, a color measuring sensor 3 that is an optical module in which the optical filter device 600 of the first embodiment is assembled, and a color measurement apparatus 1 that is an electronic apparatus in which the optical filter device 600 is assembled will be described.

### Overall Configuration of Color Measurement Apparatus

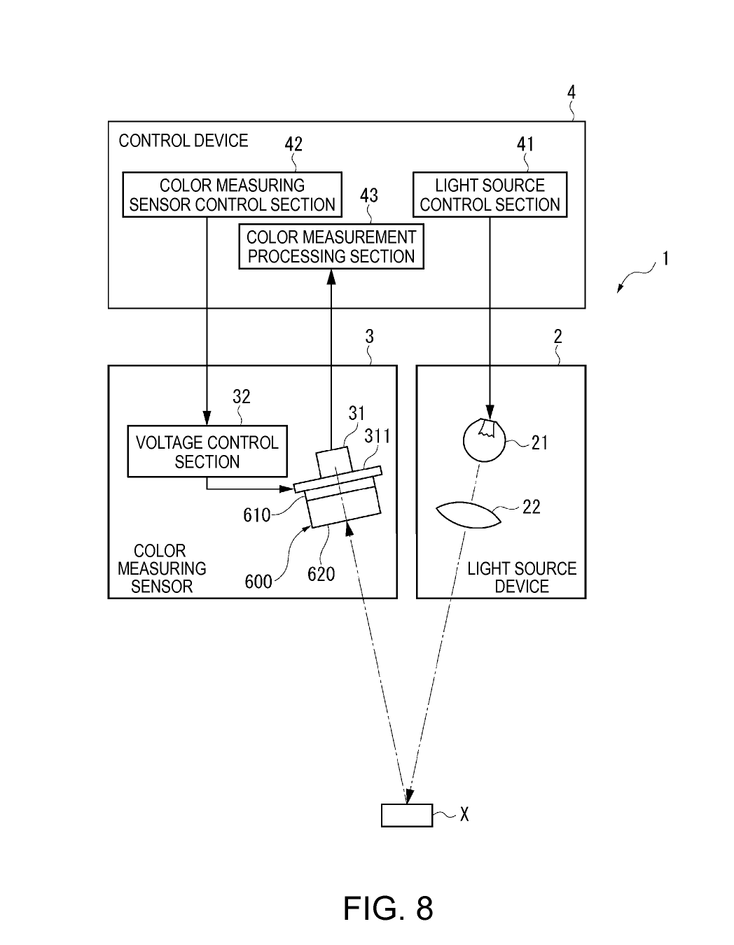

FIG. 8 is a block diagram schematically illustrating the color measurement apparatus 1.

The color measurement apparatus 1 is an electronic apparatus according to the invention. As shown in FIG. 8, the color measurement apparatus 1 includes a light source device 2 that emits light to a test target X, the color measuring sensor 3, and a control device 4 that controls an overall operation of the color measurement apparatus 1. Further, the color measurement apparatus 1 allows the light emitted from the light source device 2 to be reflected from the test target X, receives the reflected test target light by the color measuring sensor 3, and analyzes and measures chromaticity of the test target light, that is, color of the test target X, based on a detection signal output from the color measuring sensor 3.

### Configuration of Light Source Device

The light source device 2 includes a light source 21 and plural lenses 22 (in FIG. 8, only one lens is shown), and emits white light to the test target X. Further, a collimator lens may be included in the plural lenses 22. In this case, the light source device 2 changes the white light emitted from the light source 21 into parallel light by the collimator lens, to then be output toward the test target X through a projection lens (not shown). In the present embodiment, the color measurement apparatus 1 that includes the light source device 2 is shown as an example, but for example, if the test target X is a light emitting member such as a liquid crystal panel, a configuration in which the light source device 2 is not provided may be used.

### Configuration of Color Measuring Sensor

The color measuring sensor 3 forms an optical module according to the invention, and includes the optical filter device 600 of the first embodiment. As shown in FIG. 8, the color measuring sensor 3 includes the optical filter device 600, a detection section 31 that receives light passed through the wavelength variable interference filter 5 of the optical filter device 600, and a voltage control section 32 that changes the wavelength of the light passed through the wavelength variable interference filter 5.

Further, the color measuring sensor 3 includes an incident optical lens (not shown) that guides the light (test target light) reflected from the test target X to the inside at a position that faces the wavelength variable interference filter 5. Further, the color measuring sensor 3 disperses light of a predetermined wavelength included in the test target light incident from the incident optical lens by the wavelength variable interference filter 5 in the optical filter device 600, and receives the dispersed light by the detection section 31.

The detection section 31 is configured by plural photoelectric conversion elements, and generates an electrical signal based on the intensity of the received light. Here, the detection section 31 is connected to the control device 4 through a circuit board 311, for example, and outputs the generated electric signal to the control device 4 as a light reception signal.

Further, the external terminal section 616 formed on the base outer surface 613 of the base substrate 610 is connected to the circuit board 311 of the detection section 31. The detection section 31 is connected to the voltage control section 32 through the circuit formed in the circuit board 311.

With such a configuration, it is possible to integrally form the optical filter device 600 and the detection section 31 through the circuit board 311, and to simplify the configuration of the color measuring sensor 3.

The voltage control section 32 is connected to the external terminal section 616 of the optical filter device 600 through the circuit board 311. Further, the voltage control section 32 applies a predetermined step voltage between the fixed electrode pad 563P and the movable electrode pad 564P based on the control signal input from the control device 4, to drive the electrostatic actuator 56. Thus, electrostatic attraction is generated in the inter-electrode gap, and the holding section 522 is bent. Thus, the movable section 521 is displaced to the stationary substrate 51, thereby making it possible to set the inter-reflecting film gap G1 to a desired size.

### Configuration of Control Device

The control device 4 controls the overall operation of the color measurement apparatus 1.

As the control device 4, for example, a versatile personal computer, a personal digital assistant, an exclusive computer for color measurement, or the like may be used.

Further, as shown in FIG. 8, the control device 4 includes a light source control section 41, a color measuring sensor control section 42, a color measurement processing section 43, and the like.

The light source control section 41 is connected to the light source device 2. Further, the light source control section 41 outputs a predetermined control signal to the light source device 2 based on an input set by a user, for example, and allows the light source device 2 to emit white light of a predetermined brightness.

The color measuring sensor control section 42 is connected to the color measuring sensor 3. Further, the color measuring sensor control section 42 sets the wavelength of the light to be received by the color measuring sensor 3 based on an input set by the user, for example, and outputs a control signal for detecting the intensity of the received light of the wavelength to the color measuring sensor 3. Thus, the voltage control section 32 of the color measuring sensor 3 sets a voltage applied to the electrostatic actuator 56 based on the control signal to allow transmission of only the wavelength of the light desired by the user.

The color measurement processing section 43 analyzes the chromaticity of the test target X from the intensity of the received light detected by the detection section 31.

### Effects of the Third Embodiment

The color measurement apparatus 1 of the present embodiment includes the optical filter device 600 according to the first embodiment. As described above, according to the optical filter device 600, even though the movable substrate 52 and the base substrate 610 are fixed using the fixing member 7, the stress or the like due to the difference of the thermal expansion coefficients does not easily act on the movable substrate 52 or the stationary substrate 51. Thus, it is possible to suppress the warpage of the stationary reflecting film 54 of the stationary substrate 51 or the movable reflecting film 55 of the movable substrate 52. Thus, it is possible to prevent change in an optical characteristic of the wavelength variable interference filter 5 due to the warpage of the reflecting films 54 and 55. Further, in the optical filter device 600, since the air tightness of the internal space 650 is high and thus intrusion of foreign substances such as water particles does not occur, it is possible to prevent change in an optical characteristic of the wavelength variable interference filter 5 due to the foreign substances. Accordingly, in the color measuring sensor 3, it is similarly possible to detect light of a desired wavelength extracted at high resolution by the detection section 31, and to accurately detect the intensity of light for the light of the desired wavelength. Thus, the color measurement apparatus 1 can accurately perform the color analysis of the test target X.

Further, the detection section 31 is provided facing the base substrate 610, and the detection section 31 and the external terminal section 616 provided on the base outer surface 613 of the base substrate 610 are connected to one circuit board 311. That is, since the base substrate 610 of the optical filter device 600 is disposed on the light output side, it is possible to dispose the substrate 610 in the vicinity of the detection section 31 that detects the light output from the optical filter device 600. Accordingly, as described above, by forming the wire on one circuit board 311, it is possible to simplify the wire structure, and to reduce the number of boards.

Further, the voltage control section 32 may be disposed on the circuit board 311, and in this case, it is possible to further simplify the configuration.

### Modification of Embodiments

The invention is not limited to the above-described embodiments, and modifications, improvements or the like in a range capable of achieving the object of the invention are included in the invention.

For example, in each of the embodiments, a configuration in which one electrical installation surface 524 is provided is used, but the invention is not limited thereto. That is, a configuration in which plural electrical installation surfaces are respectively provided with a terminal installation region may be used.

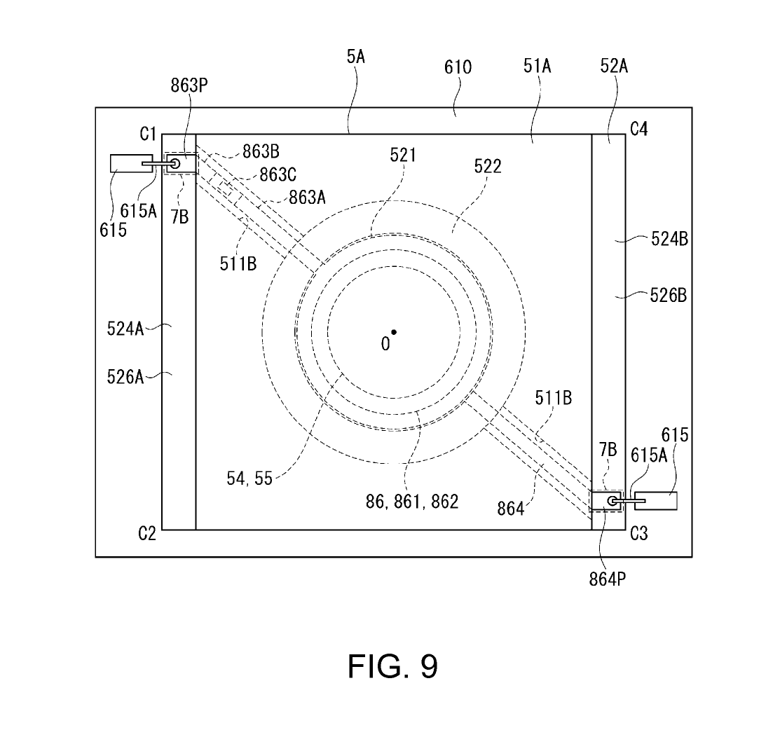

FIG. 9 is a plan view of a wavelength variable interference filter provided on the base substrate 610, when seen from the side of a stationary substrate, in a modification example of an optical filter device according to the invention. This modification example has the same configuration as in the first embodiment, except for the above-mentioned different point and an electrode structure.

A wavelength variable interference filter 5A shown in FIG. 9 includes a stationary substrate 51A and a movable substrate 52A.

In a filter plan view, one pair of sides (for example, a side C1-C2 and a side C3-C4 in FIG. 9) of the movable substrate 52A protrudes outward from the stationary substrate 51A. The protruding portions of the movable substrate 52A are non-bonding sections 526A and 526B that are not bonded to the stationary substrate 51A. Surfaces thereof exposed when seen from the side of the stationary substrate 51A form a first electrical installation surface 524A and a second electrical installation surface 524B.

An electrostatic actuator 86 is provided in the wavelength variable interference filter 5A. The electrostatic actuator 86 includes a fixed electrode 861 provided on the stationary substrate 51A and a movable electrode 862 provided on the movable substrate 52A.

A fixed extraction electrode 863A that extends toward the apex C1 from a peripheral edge of the fixed electrode 861 to the vicinity of the first electrical installation surface 524A is provided on the stationary substrate 51A. Further, a fixed connection electrode 863B that extends toward the first electrical installation surface 524A from a position that faces an extending tip portion of the fixed extraction electrode 863A is provided on the movable substrate 52A, and is connected to the fixed extraction electrode 863A by a bump electrode 863C. An extending tip portion (a part disposed at the apex C1 of the stationary substrate 51A) of the fixed connection electrode 863B forms a fixed electrode pad 863P on the first electrical installation surface 524A.

A movable extraction electrode 864 that extends toward the second electrical installation surface 524B from a peripheral edge of the movable electrode 862 is provided on the movable substrate 52A. An extending tip portion (a part disposed at the apex C3 of the movable substrate 52A) of the movable extraction electrode 864 forms a movable electrode pad 864P on the second electrical installation surface 524B.

The electrode pads 863P and 864P are connected to the internal terminals 615 provided on the base substrate 610 by the wires 615A, respectively. The connection using the wires 615A is performed by wire bonding.

A fixing member 7B is disposed at the position that overlaps a terminal installation region where the respective electrode pads 863P and 864P are provided, between the movable substrate 52A of the wavelength variable interference filter 5A and the base substrate 610 in the filter plan view.

In the present modification example, since the fixing member 7B is disposed at the position that overlaps the terminal installation region in the filter plan view, it is possible to obtain the same effects as in the first and second embodiments.

In the present modification example, the plural electrical installation surfaces 524A and 524B are provided, each terminal installation region is provided on each electrical installation surface, and the fixing member 7B is disposed to overlap each terminal installation region in the filter plan view. With such a configuration, it is possible to dividedly provide the plural electrode pads in the respective electrical installation surfaces, to reduce the size of the terminal installation region for one electrical installation surface, and to reduce the fixing area due to the fixing member 7B. Accordingly, it is possible to reduce the stress from the fixing member 7B to the movable substrate 52A on one electrical installation surface, to disperse the position where the stress from the fixing member 7B is applied, and to prevent a large amount of stress from being concentrated on one location of the movable substrate 52A.

Further, in the present modification example, the plural installation regions are provided at the positions having a symmetry relation with respect to the center of the rectangular wavelength variable interference filter 5A in the filter plan view. Accordingly, when a wire connection process is performed in one installation region, it is possible to appropriately suppress the wavelength variable interference filter 5A from being inclined with respect to the base substrate

In the above-described first and second embodiments, in the filter plan view, the fixing members 7 and 7A are disposed in the regions that overlap the respective electrode pads 541P, 551P, 563P and 564P, but the invention is not limited thereto. That is, the fixing member may be disposed at least in a region that overlaps a region pressed when the wire is provided, more specifically, in a region that overlaps the bond 615B.

In the above-described first and second embodiments, the connection between the respective electrode pads 541P, 551P, 563P and 564P and the respective internal terminals 615 is performed by the wire bonding, but for example, the electrode pads 541P, 551P, 563P and 564P and the internal terminals 615 may be bonded to each other using an Ag paste, a flexible printed circuit (FPC), an anisotropic conductive film (ACF), an anisotropic conductive paste (ACP), or the like.

In the above-described first and second embodiments, the plural electrode pads 541P, 551P, 563P and 564P are provided on one electrical installation surface, but one electronic pad may be provided on one electrical installation surface, as shown in the modification example shown in FIG. 9.

Further, in the above-described first embodiment, one terminal installation region that covers the plural electrode pads is provided on one electrical installation surface, but plural terminal installation regions may be provided on one electrical installation surface. In this case, the fixing member is disposed at a position that overlaps the respective terminal installation regions in the filter plan view.

Further, in the above-described first and second embodiments, the electrode pads are provided on the movable substrate 52, but may be provided on the stationary substrate 51. In this case, the electrode pads may be provided on the side of the stationary substrate 51 that faces the movable substrate 52, or may be provided on the opposite side thereof.

In the above-described first and second embodiments, the stationary reflecting film 54 is connected to the ground circuit (not shown) by the fixed mirror electrode 541A, the fixed mirror connection electrode 541B and the bump electrode 541C, to be set to the ground electrical potential. Similarly, the movable reflecting film 55 is connected to the ground circuit (not shown) by the movable mirror electrode 551 to be set to the ground electrical potential. That is, a configuration is shown in which an electrification preventing electrode for preventing electrification of the reflecting film is electrically connected to the connection terminal according to the invention, but the invention is not limited thereto.

For example, an electrostatic capacity detection electrode may be connected to the connection terminal according to the invention. Specifically, a configuration may be used in which the stationary reflecting film 54 and the movable reflecting film 55 are connected to an electrostatic capacity detection circuit, instead of the ground circuit, and a high frequency voltage is applied between the stationary reflecting film 54 and the movable reflecting film 55 by the electrostatic capacity detection circuit. Thus, it is possible to detect the electrostatic capacity between the reflecting films 54 and 55, that is, the size of the gap G1 between the reflecting films 54 and 55.

In the above-described first and second embodiments, as the wavelength variable interference filter, a configuration is shown in which the movable reflecting film 55 that is the first reflecting film is provided on the movable substrate 52 that is the substrate according to the invention and the stationary reflecting film 54 that is the second reflecting film is provided on the stationary substrate 51, but the invention is not limited thereto. For example, a configuration in which the stationary substrate 51 is not provided may be used. In this case, for example, a configuration is used in which the first reflecting film, the gap spacer and the second reflecting film are layered on one surface of a substrate and the first reflecting film and the second reflecting film face each other through the gap. In this configuration, due to the configuration of one sheet of substrate, it is possible to achieve reduction in the thickness of the spectroscopic element.

In the above-described respective embodiments, the optical filter device 600 in which the internal space 650 is maintained in the vacuum state is manufactured by bonding the base substrate 610 and the lid 620 in a vacuum, but the invention is not limited thereto. For example, a hole section that connects the internal space to the outside may be formed in the lid or the base substrate. After the lid and the base substrate are bonded to each other at the atmospheric pressure, by exhausting air from the internal space, it is possible to form a vacuum state and to seal the hole section by a sealing member. A metal sphere may be used as the sealing member, for example. In the sealing using the metal sphere, it is preferable that the metal sphere be inserted into the hole section and be heated at a high temperature in the hole section so that the metal sphere is welded onto the inner wall of the hole part.

Further, the wavelength variable interference filter 5 accommodated in the optical filter device 600 is not limited to the examples shown in the above-described embodiments. In the above-described embodiments, as the wavelength variable interference filter 5, a type is shown in which the size of the inter-reflecting film gap G1 can be changed by the electrostatic attraction by applying the voltage to the fixed electrode 561 and the movable electrode 562. Instead of this type, for example, a configuration may be used in which a dielectric actuator in which a first dielectric coil is disposed instead of the fixed electrode 561 and a second dielectric coil or a permanent magnet is disposed instead of the movable electrode 562 is used as the actuator that changes the inter-reflecting film gap G1.

Further, a configuration in which a piezoelectric actuator is used instead of the electrostatic actuator 56 may be used. In this case, for example, by layering a lower electrode layer, a piezoelectric layer and an upper electrode layer on the holding section 522, and by changing a voltage applied between the lower electrode layer and the upper electrode layer as an input value, it is possible to extend and contract the piezoelectric film to bend the holding section 522.

Further, as the interference filter accommodated in the internal space 650, the wavelength variable interference filter 5 is shown as an example, but for example, an interference filter in which the size of the inter-reflecting film gap G1 is fixed may be used. In this case, it is not necessary to form, by etching, the holding section 522 for bending the movable section 521, the electrode arrangement groove 511 for providing the fixed electrode 561, or the like, and it is possible to simplify the configuration of the interference filter. Further, since the size of the inter-reflecting film gap G1 is fixed, there is no problem in responsiveness, and it is not necessary to maintain the internal space 650 in the vacuum state. Thus, it is possible to simplify the configuration, and to improve the manufacturing efficiency. However, in this case, when the optical filter device 600 is used in a place where a temperature change is large, there is a concern that the base-side glass substrate 630 or the lid-side glass substrate 640 is bent by stress due to expansion of air in the internal space 650 or the like. Thus, even when such an interference filter is used, it is preferable to maintain the internal space 650 in a vacuum or decompression state.

Further, a configuration in which the lid bonding section 624, the sidewall section 625 and the top surface section 626 are provided in the lid 620 and the top surface section 626 is parallel to the base substrate 610 is shown, but the invention is not limited thereto. As the shape of the lid 620, as long as the internal space 650 capable of accommodating the wavelength variable interference filter 5 can be formed between the lid 620 and the base substrate 610, any shape may be used. For example, the top surface section 626 may be formed in a curved shape. However, in this case, the manufacturing process may be complicated. That is, in order to maintain the air tightness of the internal space 650, for example, it is necessary to form the lid-side glass substrate 640 bonded to the lid 620 in a curved shape in accordance with the lid 620, and to form only a portion for blocking the light passage hole 621 in a planar shape so that refraction or the like does not occur. Accordingly, it is preferable that the lid 620 in which the top surface section 626 is parallel to the base substrate 610 be used as in the above-described first embodiment.

In the above-described respective embodiments, an example in which the base-side glass substrate 630 and the lid-side glass substrate 640 are bonded to the outer surface of the housing 601, that is, to the base outer surface 613 of the base substrate 610 and the lid outer surface 623 of the lid 620 is shown, but the invention is not limited thereto. For example, a configuration in which the base-side glass substrate 630 and the lid-side glass substrate 640 are bonded to the side of the housing 601 that faces the internal space 650 may be used.

Further, when a reflective filter that reflects multi-interference light by the first reflecting film and the second reflecting film is accommodated in the internal space 650 as the interference filter, a configuration in which the light passage hole 611 and the base-side glass substrate 630 are not provided may be used.

In this case, a beam splitter or the like may be provided facing the light passage hole 621 of the optical filter device 600 to separate an incident light to the optical filter device 600 and an output light output from the optical filter device 600, to detect the separated output light by the detection section.

In the above-described embodiments, a configuration in which the internal terminals 615 and the external terminal section 616 are connected to each other through the conductive member in the through hole 614 formed in the base substrate 610 is shown, but the invention is not limited thereto. For example, a configuration may be used in which a rod-shaped terminal is press-fitted into the through hole 614 of the base substrate 610 and a tip portion of the terminal is connected to the fixed electrode pad 563P, the movable electrode pad 564P or the like.

In the above-described embodiments, the non-light transmissive member 515 is provided on the light incident surface of the stationary substrate 51, but for example, the non-light transmissive member 515 may be provided on the lid-side glass substrate 640 that is a light transmission substrate on the incident side.

Further, in the above-described embodiments, a configuration is shown as an example in which the optical filter device 600 that allows the wavelength variable interference filter 5 to perform multi-interference for the light incident from the side of the lid 620 and outputs the light passed through the wavelength variable interference filter 5 from the base-side glass substrate 630, but for example, a configuration in which the light is incident from the side of the base substrate 610 may be used. In this case, for example, the non-light transmissive member that serves as the aperture may be provided on the movable substrate 52, or the stationary substrate 51 in which the non-light transmissive member is provided may be fixed to the base substrate 610.

Further, as the electronic apparatus according to the invention, in the third embodiment, the color measurement apparatus 1 is shown, but in addition, it is possible to use the optical filter device, the optical module and the electronic apparatus according to the invention in various fields.

For example, it is possible to use the optical filter device, the optical module and the electronic apparatus according to the invention as a light-based system for detecting the presence of a specific material. As such a system, for example, it is possible to use a gas detection apparatus such as an in-vehicle gas leak detector that detects, with high sensitivity, a specific gas using a spectrum measurement method that uses the wavelength variable interference filter provided in the optical filter device according to the invention, or an optoacoustic noble-gas detector for breath-testing.

Hereinafter, an example of such a gas detection apparatus will be described with reference to the drawings.

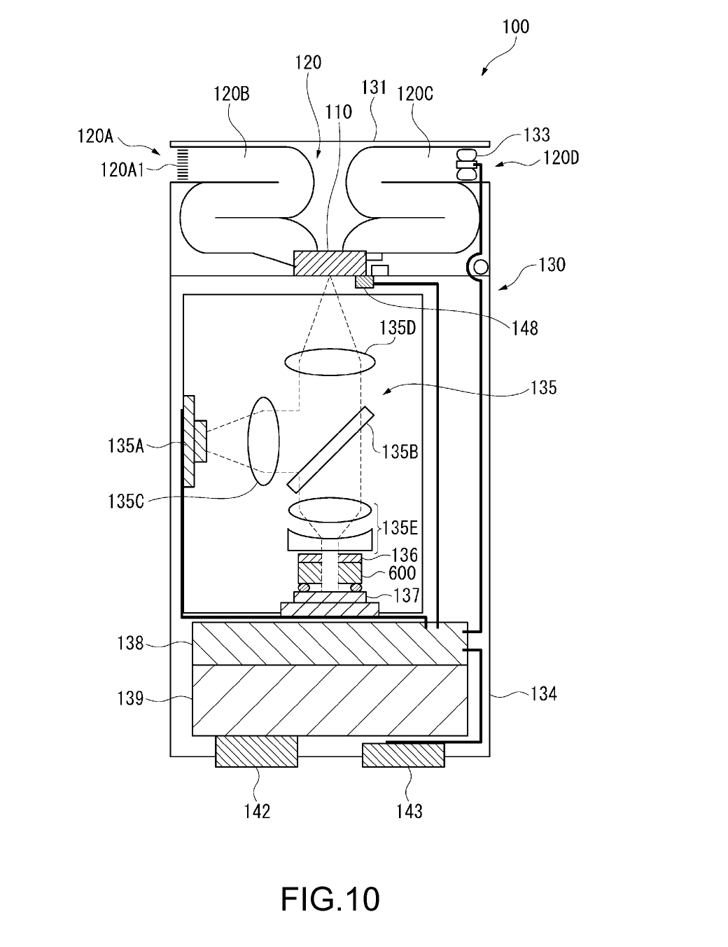

FIG. 10 is a diagram schematically illustrating an example of a gas detection apparatus provided with a wavelength variable interference filter.

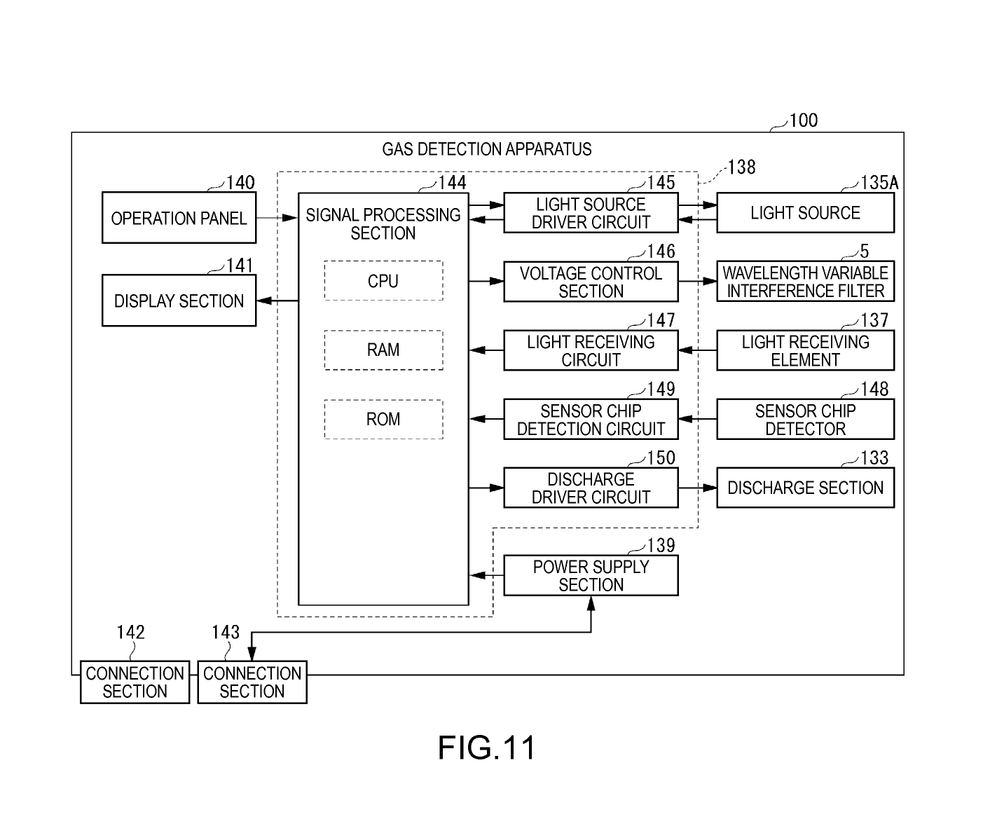

FIG. 11 is a block diagram illustrating a configuration of a control system of the gas detection apparatus in FIG. 10.

As shown in FIG. 10, a gas detection apparatus 100 includes a sensor chip 110; a flow passage 120 that has a suction port 120A, a suction flow passage 120B, a discharge flow passage 120C and a discharge port 120D; and a main body section 130.

The main body section 130 includes a detection apparatus that has a sensor section cover 131 having an opening capable of detachably forming the flow passage 120, a discharge section 133, a housing 134, an optical section 135, a filter 136, the optical filter device 600, a light receiving element 137 (detection section) and the like; a control section 138 that processes a detected signal and controls the detecting section; a power supply section 139 that supplies electric power; and the like. Further, the optical section 135 includes a light source 135A that emits light, a beam splitter 135B that reflects the incident light from the light source 135A toward the side of the sensor chip 110 and transmits the incident light from the side of the sensor chip toward the light receiving element 137; a lens 135C; a lens 135D; and a lens 135E.

Further, as shown in FIG. 11, on the surface of the gas detection apparatus 100, an operation panel 140, a display section 141, a connection section 142 for interface with the outside, and the power supply section 139 are provided. If the power supply section 139 is a secondary battery, a connection section 143 for charging may be provided.

Further, as shown in FIG. 11, the control section 138 of the gas detection apparatus 100 includes a signal processing section 144 configured by a CPU or the like; a light source driver circuit 145 for controlling the light source 135A; a voltage control section 146 for controlling the wavelength variable interference filter 5 of the optical filter device 600; a light receiving circuit 147 that receives a signal from the light receiving element 137; a sensor chip detection circuit 149 that receives a signal from a sensor chip detector 148 that reads a code of the sensor chip 110 and detects the presence or absence of the sensor chip 110; a discharge driver circuit 150 that controls the discharge section 133; and the like.

Next, an operation of the above-described gas detection apparatus 100 will be described.

The sensor chip detector 148 is provided inside the sensor section cover 131 that forms the upper part of the main body section 130, and detects the presence or absence of the sensor chip 110. The signal processing section 144 determines, if a detection signal is detected from the sensor chip detector 148, that the sensor chip 110 is mounted, and generates a display signal for indicating that the detection operation is performable to the display section 141.

Further, for example, if the operation panel 140 is operated by a user and an indication signal for starting the detection process is output to the signal processing section 144 from the operation panel 140, first, the signal processing section 144 outputs a light source operation signal to the light source driver circuit 145 to operate the light source 135A. If the light source 135A is driven, a linearly polarized stable laser light with a single wavelength is output from the light source 135A. Further, a temperature sensor or a light intensity sensor is built in the light source 135A, and its information is output to the signal processing section 144. Further, if it is determined that the light source 135A is stably operated based on the temperature or the intensity of light input from the light source 135A, the signal processing section 144 controls the discharge driver circuit 150 to operate the discharge section 133. Thus, a gas sample containing a target material (gas molecule) to be detected is guided to the suction flow passage 120B, the sensor chip 110, the discharge flow passage 120C and the discharge port 120D through the suction port 120A. A dust removal filter 120A1 is provided in the suction port 120A, in which relatively large-sized dust particles or some steam are removed.

Further, the sensor chip 110 is a sensor that is assembled with plural metal nanostructures and uses a localized surface plasmon resonance. In the sensor chip 110, an enhanced electric field is formed between the metal nanostructures by a laser light, and if gas molecules enter the enhanced electric field, a Raman scattered light and a Rayleigh scattered light containing molecular vibration information are generated.

The Rayleigh scattered light or the Raman scattered light is incident onto the filter 136 through the optical section 135. Then, the Rayleigh scattered light is separated by the filter 136, and the Raman scattered light is incident onto the optical filter device 600. Further, the signal processing section 144 controls the voltage control section 146 to adjust a voltage applied to the wavelength variable interference filter 5 of the optical filter device 600, and spectrally disperses the Raman scattered light corresponding to the gas molecules that are a detection target by the wavelength variable interference filter 5 of the optical filter device 600. Then, if the spectrally dispersed light is received by the light receiving element 137, the light receiving signal according to the intensity of the received light is output to the signal processing section 144 through the light receiving circuit 147.

The signal processing section 144 compares spectral data of the Raman scattered light corresponding to the gas molecules that are the detection target, obtained as described above, with data stored in a ROM to determine whether desired gas molecules are present, and thus, specifies a material. Further, the signal processing section 144 displays information on the result in the display section 141, or outputs the result information to the outside through the connection section 142.

In FIGS. 10 and 11, the gas detection apparatus 100 is shown in which the Raman scattered light is spectrally dispersed by the wavelength variable interference filter 5 of the optical filter device 600 and the gas detection is performed based on the spectrally dispersed Raman scattered light. Alternatively, as the gas detection apparatus, a gas detection apparatus that specifies the type of gas by detecting a gas-specific absorbance may be used. In this case, a gas sensor that allows gas to flow into the sensor and detects light absorbed into the gas, among incident light beams, may be used as the optical module according to the invention. Further, a gas detection apparatus that analyzes and determines, by the gas sensor, the gas that flows into the sensor is used as the electronic apparatus according to the invention. With such a configuration, it is similarly possible to detect the component of the gas using the wavelength variable interference filter.

Further, as the system for detecting the presence of the specific material, besides the gas detection as described above, a substance component analysis apparatus such as a non-invasive measurement apparatus of a sugar group using near-infrared dispersion or a non-invasive measurement apparatus of information on food, biological objects, minerals or the like may be used.

Hereinafter, a food analysis apparatus will be described as an example of the substance component analysis apparatus that uses the optical filter device 600.

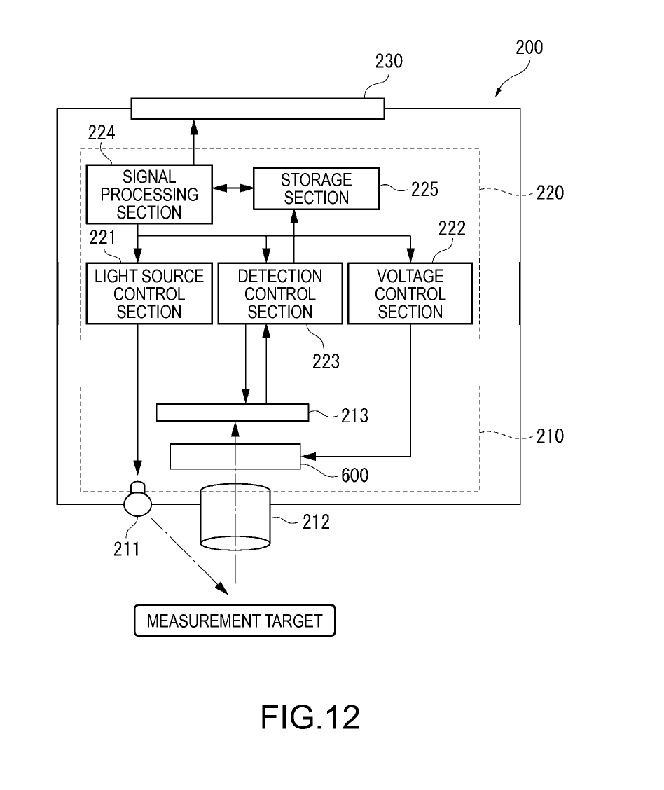

FIG. 12 is a diagram schematically illustrating a configuration of a food analysis apparatus that is an example of an electronic apparatus that uses the optical filter device 600.

As shown in FIG. 12, a food analysis apparatus 200 includes a detector 210 (optical module), a control section 220, and a display section 230. The detector 210 includes a light source 211 that emits light, an imaging lens 212 through which light from a measurement target is input, the optical filter device 600 that spectrally disperses the light input from the imaging lens 212, and an imaging section 213 (detection section) that detects the spectrally dispersed light.

Further, the control section 220 includes a light source control section 221 that performs a lighting control and a brightness control in lighting of the light source 211; a voltage control section 222 that controls the wavelength variable interference filter 5 of the optical filter device 600; a detection control section 223 that controls the imaging section 213 to obtain a spectroscopic image captured by the imaging section 213; a signal processing section 224; and a storage section 225.

In the food analysis apparatus 200, if the system is driven, the light source 211 is controlled by the light source control section 221, and thus, light is emitted from the light source 211 toward the measurement target. Further, the light reflected from the measurement target passes through the imaging lens 212 to be incident onto the optical filter device 600. The wavelength variable interference filter 5 of the optical filter device 600 is applied with a voltage capable of spectrally dispersing a desired wavelength under the control of the voltage control section 222, and the dispersed light is imaged by the imaging section 213 that is configured by a CCD camera or the like, for example. Then, the imaged light is stored in the storage section 225 as a spectroscopic image. Further, the signal processing section 224 controls the voltage control section 222 to change a value of the voltage applied to the wavelength variable interference filter 5, and obtains a spectroscopic image for each wavelength.

Further, the signal processing section 224 performs data processing for each pixel in each image stored in the storage section 225 to calculate a spectrum in each pixel. Further, information relating to a component of food for the spectrum is stored in the storage section 225, for example. The signal processing section 224 analyzes the data on the calculated spectrum based on the information relating to the food stored in the storage section 225 to calculate a food component contained in the detection target and content thereof. Further, it is possible to calculate calories, freshness or the like of the food from the obtained food component and content. Further, by analyzing a spectrum distribution in the image, for example, it is possible to extract a portion where the freshness is degraded in the food that is the detection target, and to detect a foreign material or the like contained in the food.

Further, the signal processing section 224 performs a process of displaying information about the component, content, calories, freshness or the like of the food that is the detection target, obtained as described above, in the display section 230.

Further, in FIG. 12, an example of the food analysis apparatus 200 is shown, but it is possible to use approximately the same configuration as the non-invasive measurement apparatuses, as described above, relating to other information. For example, it is possible to use the configuration as a biological object analysis apparatus that analyzes a biological object component such as measurement and analysis of a biological fluid component such as blood. As the biological object analysis apparatus, for example, if an apparatus that detects an ethyl alcohol is used as an apparatus that measures a biological fluid component such as blood, it is possible to use the configuration as an alcohol influence driving prevention apparatus that detects a drunken state of a driver. Further, it is possible to use the configuration as an electronic endoscopic system provided with such a biological object analysis apparatus.

Furthermore, it is possible to use the configuration as a mineral analysis apparatus that analyzes a component of mineral.

Further, the wavelength variable interference filter, the optical module and the electronic apparatus according to the invention may be applied to the following apparatuses.

For example, by changing the intensity of light of each wavelength with time, it is possible to transmit data using the light of each wavelength. In this case, by spectrally dispersing light of a specific wavelength by the wavelength variable interference filter provided in the optical module and allowing a light receiving section to receive the light, it is possible to extract data transmitted using the light of the specific wavelength. Further, by processing the data of the light of each wavelength by the electronic apparatus provided with an optical module for the data extraction, it is possible to perform optical communication.

Further, the electronic apparatus may be applied to a spectroscopic camera, a spectroscopic analysis apparatus or the like that images a spectroscopic image by spectrally dispersing light by the wavelength variable interference filter provided in the optical filter device according to the invention. As an example of such a spectroscopic camera, an infrared camera in which the wavelength variable interference filter is built may be used.

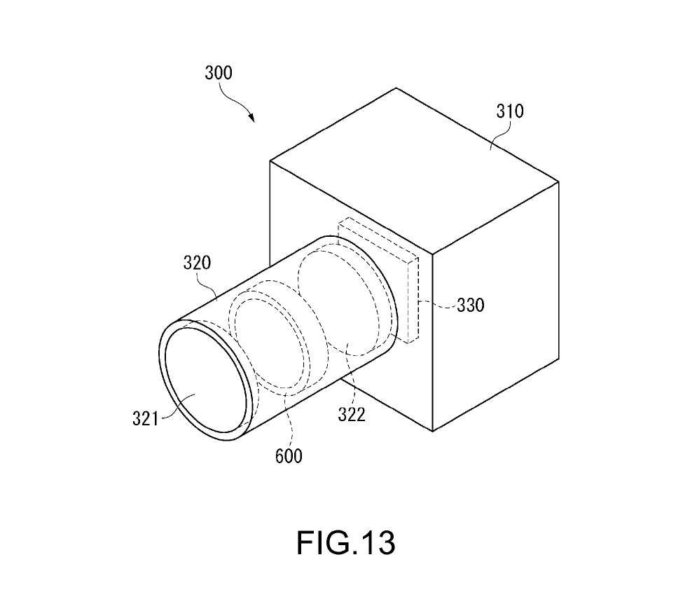

FIG. 13 is a diagram schematically illustrating an outline of a configuration of a spectroscopic camera. As shown in FIG. 13, a spectroscopic camera 300 includes a camera body 310, an imaging lens unit 320, and an imaging section 330 (detection section).

The camera body 310 is a portion that is gripped and operated by a user.

The imaging lens unit 320 is provided in the camera body 310, and guides an incident image light to the imaging section 330. Further, as shown in FIG. 13, the imaging lens unit 320 includes an objective lens 321, an imaging lens 322, and the optical filter device 600 provided between the lenses.

The imaging section 330 is configured by a light receiving element, and images the image light guided by the imaging lens unit 320.

In such a spectroscopic camera 300, as the wavelength variable interference filter 5 of the optical filter device 600 transmits light of a wavelength that is an imaging target, it is possible to obtain a spectroscopic image of light of a desired wavelength.

Further, the wavelength variable interference filter provided in the optical filter device according to the invention may be used as a band pass filter, and for example, may be used as an optical laser apparatus that spectrally disperses for transmission only light of a narrow band around a predetermined wavelength, in light of a predetermined wavelength band emitted from a light emitting element, by the wavelength variable interference filter.

Further, the wavelength variable interference filter provided in the optical filter device according to the invention may be used as a biological object authentication apparatus, and for example, may be applied to an authentication apparatus of a blood vessel, a fingerprint, a retina or an iris, using light of a near infrared region or a visible region.

Furthermore, the optical module and the electronic apparatus may be used as a concentration detector. In this case, infrared energy output from a material (infrared light) is spectrally dispersed by the wavelength variable interference filter for analysis, to measure a test specimen concentration in a sample.

As described above, the optical filter device and the electronic apparatus according to the invention may be applied to any apparatus that spectrally disperses a predetermined light from an incident light. Further, in the optical filter device according to the invention, as described above, since it is possible to spectrally disperse plural wavelengths using one device, it is possible to measure spectra of plural wavelengths and to perform detection for plural components with high accuracy. Accordingly, compared with a related art device that extracts a desired wavelength by plural devices, it is possible to promote a reduction in size of the optical module or the electronic apparatus, and for example, it is possible to preferably use the optical filter device according to the invention as a mobile or in-vehicle optical device.

In the above description of the color measurement apparatus 1, the gas detection apparatus 100, the food analysis apparatus 200 and the spectroscopic camera 300, an example is shown in which the optical filter device 600 according to the first embodiment is applied, but the invention is not limited thereto. That is, the optical filter device according to the other embodiments or a different optical filter device included in the invention may be similarly applied to the color measurement apparatus 1 or the like.

Further, a specific structure in realization of the invention may be configured by an appropriate combination of the above-described embodiments and modification examples, or by appropriate modification into different structures, within a range capable of achieving the objects of the invention.

The entire disclosure of Japanese Patent Application No. 2013-061548 filed on Mar. 25, 2013 is expressly incorporated by reference herein.

What is claimed is:

1. An optical filter device comprising:
an interference filter provided with a substrate on which a connection terminal is provided;
a base substrate on which the interference filter is mounted, facing the substrate; and
a fixing member that is disposed between the substrate and the base substrate, and fixes the substrate to the base substrate,
wherein the fixing member is disposed at a position that overlaps the connection terminal, in a plan view of the substrate and the base substrate, seen in a substrate thickness direction.

2. The optical filter device according to claim 1, further comprising:
a housing that includes the base substrate and accommodates the interference filter fixed to the base substrate,
wherein the housing includes a housing-side terminal that is electrically connected to the connection terminal by wire bonding.

3. The optical filter device according to claim 1,
wherein the plurality of the connection terminals are provided, and the connection terminals are arranged in one direction, and
wherein the fixing member is arranged over the plurality of the connection terminals in a plan view.

4. The optical filter device according to claim 1,
wherein the plurality of the connection terminals are provided, and
wherein the fixing member is individually disposed at a position that overlaps each of the plurality of the connection terminals in a plan view.

5. The optical filter device according to claim 1,
wherein the substrate includes a terminal installation section that has a terminal installation region having an approximately rectangular appearance, in which the connection terminal is disposed on one side of the rectangle, and
wherein the length of the terminal installation region in a first direction parallel to one side of the rectangle is 30% or less of the length of the terminal installation section.

6. The optical filter device according to claim 1,
wherein the fixing member is an Ag paste.

7. An optical module comprising:
an interference filter provided with a substrate on which a connection terminal is provided;
a base substrate on which the interference filter is mounted, facing the substrate;
a fixing member that is disposed between the substrate and the base substrate, and fixes the substrate to the base substrate; and
a detection section that detects light extracted by the interference filter,
wherein the fixing member is disposed at a position that overlaps the connection terminal, in a plan view of the substrate and the base substrate, seen in a substrate thickness direction.

8. An electronic apparatus comprising:
an interference filter provided with a substrate on which a connection terminal is provided;
a base substrate on which the interference filter is mounted, facing the substrate;
a fixing member that is disposed between the substrate and the base substrate, and fixes the substrate to the base substrate; and
a control section that controls the interference filter,
wherein the fixing member is disposed at a position that overlaps the connection terminal, in a plan view of the substrate and the base substrate, seen in a substrate thickness direction.
